(19) United States
(12) Patent Application Publication
(10) Pub. No.: US 2025/0230271 A1
(43) Pub. Date: Jul. 17, 2025

(54) POLYCARBODIIMIDE COMPOUND, RESIN COMPOSITION, AND RESIN CURED PRODUCT

(71) Applicant: NISSHINBO CHEMICAL INC., Tokyo (JP)

(72) Inventors: Shinichi NAKASHIMA, Chiba-shi (JP); Yuma SAITO, Chiba-shi (JP); Yoshiaki KOBAYASHI, Chiba-shi (JP)

(73) Assignee: NISSHINBO CHEMICAL INC., Tokyo (JP)

(21) Appl. No.: 18/854,701

(22) PCT Filed: Jun. 27, 2023
(86) PCT No.: PCT/JP2023/023699

§ 371 Date: Oct. 7, 2024

(30) Foreign Application Priority Data
Jun. 27, 2022 (JP) 2022-103006

(51) Int. Cl. C08G 18/79; C08F 285/00; C08F 299/06; C08G 18/62; C08G 18/67; C08G 18/69; C08G 18/75

(52) U.S. Cl. CPC C08G 18/797; C08F 285/00; C08F 299/065; C08G 18/6208; C08G 18/672; C08G 18/69; C08G 18/75

(57) ABSTRACT

A polycarbodiimide compound, which is a reaction product of a polycarbodiimide (a) having an isocyanate group at both ends, obtained by polymerizing at least one selected from aliphatic diisocyanate and alicyclic diisocyanate, and a polymer (b) that is a polymer of at least one selected from butadiene and isoprene or a hydrogenated product thereof and has a functional group capable of reacting with an isocyanate group.

### TECHNICAL FIELD

The present invention relates to a polycarbodiimide compound, a resin composition containing the polycarbodiimide compound, and a cured product of the resin composition.

### BACKGROUND ART

Utilizing the high reactivity of a carbodiimide group, a polycarbodiimide compound is widely used as a hydrolysis stabilizer for compounds containing an ester group and as a crosslinking agent for resins containing a carboxy group, which is a group that is capable of reacting with a carbodiimide group.

For example, PTL 1 describes a compound in which 2-hydroxyethyl acrylate is added to carbodiimide.

PTL 2 describes a carbodiimide compound in which a polybutadiene chain is introduced as a side chain of a carbodiimide compound by reacting a functional group of a polybutadiene compound having the functional group that reacts with a carbodiimide group, with the carbodiimide group of the carbodiimide compound.

PTL 3 describes a polycarbodiimide copolymer having a soft segment derived from a polyol and a hard segment derived from an aromatic polycarbodiimide.

### CITATION LIST

### Patent Literature

PTL 1: JPH 9-309871 A

PTL 2: JP 2006-257243 A

PTL 3: WO 2018/092752 A

### SUMMARY OF INVENTION

### Technical Problem

However, the carbodiimide compounds and polycarbodiimide compounds described in PTLs 1 to 3 were not sufficiently effective in improving the water resistance of resins having a (meth)acryloyl group.

An object of the present invention is to provide a polycarbodiimide compound that has an excellent effect of improving the water resistance of a resin having a (meth)acryloyl group, a resin composition containing a resin having a (meth)acryloyl group and the polycarbodiimide compound and having excellent water resistance, and a cured product of the resin composition.

### Solution to Problem

The present invention provides the following [1] to [14].
[1] A polycarbodiimide compound, which is a reaction product of
a polycarbodiimide (a) having an isocyanate group at both ends, obtained by polymerizing at least one selected from aliphatic diisocyanate and alicyclic diisocyanate, and
a polymer (b) that is a polymer of at least one selected from butadiene and isoprene or a hydrogenated product thereof and has a functional group capable of reacting with an isocyanate group.
[2] The polycarbodiimide compound according to the above [1], in which the polycarbodiimide (a) has a degree of polymerization of 2 to 20.
[3] The polycarbodiimide compound according to the above [1] or [2], in which the polycarbodiimide (a) has a theoretical molecular weight of 400 to 8,000.
[4] The polycarbodiimide compound according to any one of the above [1] to [3], in which the at least one selected from aliphatic diisocyanate and alicyclic diisocyanate is at least one selected from dicyclohexylmethane-4,4′-diisocyanate, isophorone diisocyanate, and tetramethylxylylene diisocyanate.
[5] The polycarbodiimide compound according to any one of the above [1] to [4], in which the polymer (b) is blended in an amount of 10 to 300 parts by mass based on 100 parts by mass of the polycarbodiimide (a).
[6] The polycarbodiimide compound according to any one of the above [1] to [5], in which the polymer (b) has a number average molecular weight of 500 to 5,000.
[7] The polycarbodiimide compound according to any one of the above [1] to [6], in which the functional group capable of reacting with the isocyanate group of the polymer (b) is at least one selected from an isocyanate group, a hydroxy group, an amino group, and a carboxy group.
[8] The polycarbodiimide compound according to any one of the above [1] to [7], which is a reaction product of
the polycarbodiimide (a),
the polymer (b), and
a compound (c) having a (meth)acryloyl group and a functional group that is capable of reacting with an isocyanate group.
[9] The polycarbodiimide compound according to the above [8], in which the polycarbodiimide (a) is blended in an amount of 20 to 80% by mass in a total blending amount of 100% by mass of the polycarbodiimide (a), the polymer (b), and the compound (c).
[10] The polycarbodiimide compound according to the above [8] or [9], in which the functional group capable of reacting with the isocyanate group of the compound (c) is at least one selected from an isocyanate group, a hydroxy group, an amino group, and a carboxy group.
[11] The polycarbodiimide compound according to any one of the above [8] to [10], in which the compound (c) is monohydroxyalkyl (meth) acrylate.
[12] A resin composition containing a resin (D) having a (meth)acryloyl group and the polycarbodiimide compound according to any one of the above [1] to [11].
[13] The resin composition according to the above [12], further containing a radical polymerization initiator (E).
[14] A resin cured product, which is a cured product of the resin composition according to the above or [13].
[15] A method for producing a polycarbodiimide compound, which is a reaction product of
a polycarbodiimide (a) having an isocyanate group at both ends, obtained by polymerizing at least one selected from aliphatic diisocyanate and alicyclic diisocyanate, and
a polymer (b) that is a polymer of at least one selected from butadiene and isoprene or a hydrogenated product thereof and has a functional group capable of reacting with an isocyanate group,
the method including reacting the polycarbodiimide (a) and the polymer (b) at 120° C. or lower.
[16] A method for producing a polycarbodiimide compound, which is a reaction product of
a polycarbodiimide (a) having an isocyanate group at both ends, obtained by polymerizing at least one selected from aliphatic diisocyanate and alicyclic diisocyanate,
a polymer (b) that is a polymer of at least one selected from butadiene and isoprene or a hydrogenated product thereof and has a functional group capable of reacting with an isocyanate group, and
a compound (c) having a (meth)acryloyl group and a functional group that is capable of reacting with an isocyanate group,
the method including reacting the polycarbodiimide (a), the polymer (b), and the compound (c) at 120° C. or lower.
[17] A method for producing a polycarbodiimide compound, which is a reaction product of
a polycarbodiimide (a) having an isocyanate group at both ends, obtained by polymerizing at least one selected from aliphatic diisocyanate and alicyclic diisocyanate, and
a polymer (b) that is a polymer of at least one selected from butadiene and isoprene or a hydrogenated product thereof and has a functional group capable of reacting with an isocyanate group,
the method including reacting the polycarbodiimide (a) and the polymer (b) in a solvent.
[18] A method for producing a polycarbodiimide compound, which is a reaction product of
a polycarbodiimide (a) having an isocyanate group at both ends, obtained by polymerizing at least one selected from aliphatic diisocyanate and alicyclic diisocyanate,
a polymer (b) that is a polymer of at least one selected from butadiene and isoprene or a hydrogenated product thereof and has a functional group capable of reacting with an isocyanate group, and
a compound (c) having a (meth)acryloyl group and a functional group that is capable of reacting with an isocyanate group,
the method including reacting the polycarbodiimide (a), the polymer (b), and the compound (c) in a solvent.
[19] A resin composition containing a resin (D) having a (meth)acryloyl group and the polycarbodiimide compound obtained by the production method according to any one of the above to [18].
[20] The resin composition according to the above [19], further containing a radical polymerization initiator (E).
[21] A resin cured product, which is a cured product of the resin composition according to the above or [20].

### Advantageous Effects of Invention

According to the present invention, it is possible to provide a polycarbodiimide compound having excellent effect in improving the water resistance of a resin having a (meth)acryloyl group.

Further, according to the present invention, it is possible to provide a (meth)acryloyl group-containing resin composition that contains the polycarbodiimide compound and has excellent water resistance, and a cured product thereof.

### DESCRIPTION OF EMBODIMENTS

Hereinafter, the polycarbodiimide compound, the resin composition, and the resin cured product of the present invention will be explained in detail.

In the present invention, the “(meth)acryloyl group” means an acryloyl group or a methacryloyl group.

### Polycarbodiimide Compound

The polycarbodiimide compound according to the present invention is a polycarbodiimide compound that is a reaction product of
a polycarbodiimide (a) having an isocyanate group at both ends, obtained by polymerizing at least one selected from aliphatic diisocyanate and alicyclic diisocyanate, and
a polymer (b) that is a polymer of at least one selected from butadiene and isoprene or a hydrogenated product thereof and has a functional group capable of reacting with an isocyanate group.

The polycarbodiimide compound has an effect of improving the water resistance of the resin (D) having a (meth)acryloyl group. Although the reason for the effect is unknown, it is presumed to be as follows.

In the cured product of the resin composition containing the resin (D) having a (meth)acryloyl group and the polycarbodiimide compound, the carbodiimide group derived from the polycarbodiimide (a) reacts with water molecules that have entered the cured product, thereby producing an excellent effect of inhibiting the entered water molecules from deteriorating the cured product.

Further, the polycarbodiimide compound has, in its main chain, a structure derived from the polymer (b) that is a polymer of at least one selected from butadiene and isoprene or a hydrogenated product thereof and has a functional group capable of reacting with an isocyanate group. The polymer (b) facilitates the compatibilization of the polycarbodiimide compound and the resin (D) having a (meth)acryloyl group, and therefore, the obtained cured product can maintain a uniform structure in which the polycarbodiimide compound and the resin (D) having a (meth)acryloyl group are made compatible even under high temperature and high humidity conditions. In addition, since the polymer (b) is incorporated into a crosslinked structure without inhibiting the reactivity of the polycarbodiimide group, it has an excellent effect of improving the strength, water resistance, and durability of the cured product.

Furthermore, since the polymer (b) has a functional group that can react with an isocyanate group, when the polymer (b) is bonded to the polycarbodiimide (a), the functional group capable of reacting with an isocyanate group of the polymer (b) will be bonded to a terminal isocyanate group of the polycarbodiimide (a). Therefore, the carbodiimide group of the polycarbodiimide (a) is prevented from bonding with the polymer (b) to reduce the number of carbodiimide groups, and the above-mentioned effects due to the carbodiimide groups are prevented from decreasing.

The polycarbodiimide compound is preferably a reaction product of the polycarbodiimide (a), the polymer (b), and a compound (c) having a (meth)acryloyl group and a functional group that is capable of reacting with an isocyanate group. The polycarbodiimide compound has a (meth)acryloyl group and can react with the resin (D) having a (meth)acryloyl group, and thus the carbodiimide group can be uniformly distributed in the cured product. As a result, water resistance is improved.

<Polycarbodiimide (a)>

The polycarbodiimide (a) is a polycarbodiimide having an isocyanate group at both ends, obtained by polymerizing at least one selected from aliphatic diisocyanate and alicyclic diisocyanate.

Here, the aliphatic diisocyanate means a diisocyanate in which each of two isocyanate groups is bonded to a carbon constituting an aliphatic hydrocarbon structure.

Here, an alicyclic diisocyanate means a diisocyanate in which each of two isocyanate groups is bonded to a carbon constituting an aliphatic hydrocarbon structure or an alicyclic hydrocarbon structure, and the carbon to which at least one of the two isocyanate groups is bonded is a carbon constituting the alicyclic hydrocarbon structure. The alicyclic diisocyanate is preferably a diisocyanate in which each of two isocyanate groups is bonded to a carbon constituting an alicyclic hydrocarbon structure.

Specific examples of the aliphatic diisocyanate include hexamethylene diisocyanate, 2,5(2,6)-bis(isocyanatomethyl)bicyclo[2.2.1]heptane, and tetramethylxylylene diisocyanate (TMXDI).

Specific examples of the alicyclic diisocyanate include dicyclohexylmethane-4,4′-diisocyanate (HMDI), cyclohexane-1,4-diisocyanate, isophorone diisocyanate (IPDI), and methylcyclohexane diisocyanate (1-methylcyclohexane-2,4-diyl diisocyanate).

Among these, dicyclohexylmethane-4,4′-diisocyanate (HMDI), tetramethylxylylene diisocyanate (TMXDI), and isophorone diisocyanate (IPDI) are preferred from the viewpoint of ease of synthesis of the polycarbodiimide compound, and an effect of improving the storage stability of the synthesized polycarbodiimide compound and the water resistance of the resin, and dicyclohexylmethane-4,4′-diisocyanate (HMDI) is more preferred from the viewpoint of storage stability and reactivity of carbodiimide groups.

From the viewpoint of preventing gelation during synthesis of the polycarbodiimide compound, the degree of polymerization of the polycarbodiimide (a) is preferably 20 or less, more preferably 15 or less, still more preferably 13 or less, and even more preferably 9 or less. Further, from the viewpoint of reactivity with the resin, the degree of polymerization is preferably 2 or more, and more preferably 3 or more. Furthermore, from the viewpoint of improving the water resistance of the resin, the degree of polymerization is preferably 2 to 20, more preferably 2 to 15, still more preferably 2 to 13, even more preferably 3 to 9, and the most preferable range is 5 to 9.

The degree of polymerization can be measured by the method described in Examples.

Here, the degree of polymerization of the polycarbodiimide (a) represents the number of carbodiimide groups in polycarbodiimide (precursor of polycarbodiimide compound) having isocyanate groups at both ends obtained by polymerizing a diisocyanate compound. For example, the degree of polymerization n of a polycarbodiimide having two carbodiimide groups obtained by polymerizing three diisocyanate compounds is 2.

The theoretical molecular weight of the polycarbodiimide (a) is preferably 400 to 8,000, more preferably 500 to 6,000, still more preferably 600 to 4,000, even more preferably 600 to 3,500, and further more preferably 600 to 3,000. The theoretical molecular weight can be calculated based on the molecular weight and degree of polymerization of the raw material diisocyanate compound.

The method for producing the polycarbodiimide (a) is not particularly limited, and any known production method can be used. For example, synthesis methods shown in (al) to (a3) below can be mentioned.
(a1) A method of carrying out a carbodiimidization reaction of a diisocyanate compound in the presence of a catalyst to obtain an isocyanate-terminated polycarbodiimide compound, and then carrying out an end-capping reaction by adding an organic compound (end-capping agent) having a functional group that is capable of reacting with an isocyanate group
(a2) A method of mixing a diisocyanate compound and an organic compound (end-capping agent) having a functional group capable of reacting with an isocyanate group, and carrying out a carbodiimidization reaction and an end-capping reaction in the presence of a catalyst
(a3) A method of carrying out an end-capping reaction of an isocyanate group by reacting a diisocyanate compound with an organic compound (end-capping agent) having a functional group capable of reacting with an isocyanate group, and then carrying out a carbodiimidization reaction in the presence of a catalyst

Among these synthesis methods, method (a1) or (a3) is preferred from the viewpoint of controlling the degree of polymerization of a carbodiimide group and production efficiency.

The carbodiimidization reaction is preferably, for example, polymerization (decarboxylation condensation reaction) of a diisocyanate compound in the presence of a carbodiimidization catalyst (see U.S. Pat. No. 2,941,956, JPS 47-33279 A, J. Org. Chem. 28, p. 2069-2075 (1963), Chemical Review 1981, Vol. 81, No. 4, p. 619-621, etc.).

Examples of the carbodiimidization catalyst include phosphorene oxides such as 1-phenyl-2-phosphorene-1-oxide, 3-methyl-1-phenyl-2-phosphorene-1-oxide, 1-ethyl-2-phosphorene-1-oxide, 3-methyl-2-phosphorene-1-oxide, and 3-phosphorene isomers thereof. Among these, 3-methyl-1-phenyl-2-phosphorene-1-oxide is preferable in view of reactivity and availability.

The amount of the carbodiimidization catalyst to be used is generally preferably 0.01 to 10 parts by mass, more preferably 0.05 to 5 parts by mass, and even more preferably 0.07 to 3 parts by mass, with respect to 100 parts by mass of the diisocyanate compound.

<Polymer (b)>

The polymer (b) is a polymer of at least one selected from butadiene and isoprene or a hydrogenated product thereof and has a functional group capable of reacting with an isocyanate group.

Since the polymer (b) has a functional group that is capable of reacting with an isocyanate group, the functional group reacts with an isocyanate group present at an end of the polycarbodiimide (a). Therefore, when reacting the polymer (b) with the poly carbodiimide (a), a reaction between the end of the polymer (b) and the carbodiimide group in the polycarbodiimide (a) is avoided. Therefore, the carbodiimide equivalent of the obtained polycarbodiimide compound can be increased. In addition, it is also prevented that the end of the polymer (b) and the carbodiimide group in the polycarbodiimide (a) react to form a butadiene structure or an isoprene structure in a side chain of the polycarbodiimide compound, and the reaction of carbodiimide groups present in the vicinity is alienated by the butadiene structure or the isoprene structure.

The polymer (b) is preferably a polymer of butadiene (polybutadiene) or a hydrogenated product thereof or a polymer of isoprene (polyisoprene) or a hydrogenated product thereof and a polymer having a functional group capable of reacting with an isocyanate group, and more preferably a polymer of butadiene (poly butadiene) or a hydrogenated product thereof and a polymer having a functional group capable of reacting with an isocyanate group.

The polymer (b) is more preferably an unhydrogenated product of a polymer from the viewpoint of improving the water resistance of the resin.

Examples of the functional group that is capable of reacting with an isocyanate group include an isocyanate group, a hydroxy group, an amino group, and a carboxy group, and preferably a hydroxy group from the viewpoint of ease of production, ease of obtaining raw materials, and good storage stability of the poly carbodiimide compound.

The number average molecular weight of the polymer (b) is preferably 500 to 5,000, more preferably 1,000 to 4,000, still more preferably 1,000 to 3,500, even more preferably 1,000 to 3,000, and further more preferably 1,200 to 2,500. When the number average molecular weight is 500 or more, it can be expected that the compatibility with the resin (D) having a (meth)acryloyl group will increase and the effect of improving water resistance will be improved. When the number average molecular weight is 5,000 or less, the ratio of carbodiimide groups in the molecule is high, and thus the effect due to carbodiimide groups becomes high.

The number average molecular weight can be measured by the method described in Examples.

The number of functional groups capable of reacting with isocyanate groups per molecule of the polymer (b) is 1 or 2 or more, and from the viewpoint of good storage stability of the carbodiimide compound and ease of production, the number is preferably 2 or more, more preferably 2.

<Compound (c)>

The compound (c) is a compound that has a (meth)acryloyl group and a functional group that is capable of reacting with an isocyanate group.

When the polycarbodiimide compound has a structural unit derived from the compound (c), since the polycarbodiimide compound has a (meth)acryloyl group and can react with the resin (D) having a (meth)acryloyl group, the carbodiimide groups can be uniformly distributed in the cured product, resulting in an effect of improved water resistance.

Examples of the functional group that is capable of reacting with an isocyanate group include an isocyanate group, a hydroxy group, an amino group, and a carboxy group, and preferably a hydroxy group from the viewpoint of ease of production, ease of obtaining raw materials, and good storage stability of the carbodiimide compound.

The number of (meth)acryloyl groups per molecule of the compound (c) is 1 or 2 or more, and preferably 3 or less.

The number of functional groups capable of reacting with isocyanate groups per molecule of the compound (c) is 1 or 2 or more, and from the viewpoint of ease of production, ease of obtaining raw materials, and good storage stability of the carbodiimide compound, the number is preferably 1 or 2, more preferably 1.

The compound (c) is preferably monohydroxyalkyl (meth)acrylate.

In addition, the compound (c) is preferably a (meth)acrylate containing one hydroxy group (hereinafter referred to as “hydroxy group-containing (meth)acrylate”), and more preferably a hydroxy group-containing (meth)acrylate having 5 or more and 15 or less carbon atoms.

Examples of hydroxy group-containing (meth)acrylates include 2-hydroxyethyl (meth)acrylate, hydroxypropyl (meth)acrylate, hydroxybutyl (meth)acrylate, 2-acryloyloxyethyl-2-hydroxyethylphthalic acid, glycerol mono (meth)acrylate, 2-hydroxy-3-phenoxypropyl acrylate, and pentaerythritol tri (meth)acrylate, and are preferably 2-hydroxyethyl (meth)acrylate, hydroxypropyl (meth)acrylate, and hydroxybutyl (meth)acrylate.

### <Other Components>

Within a range that does not impair the effects of the present invention, the polycarbodiimide compound according to the present invention may also be a reaction product of the polycarbodiimide (a), the polymer (b), the compound (c) having a (meth)acryloyl group and a functional group that is capable of reacting with an isocyanate group, and other components. However, from the viewpoint of achieving the effects of the present invention. the polycarbodiimide compound is preferably a reaction product of only the three, the polycarbodiimide (a), the polymer (b), and the compound (c) having a (meth)acryloyl group and a functional group that is capable of reacting with an isocyanate group.

Examples of other components include compounds having a functional group that is capable of reacting with an isocyanate group, for example, compounds having a hydroxy group, such as butanol (e.g., 1-butanol), ethylene glycol, and propylene glycol, compounds having an amino group, such as butylamine and cyclohexylamine, and compounds having a carboxy group, such as a propionic acid and a butanoic acid.

### <Blending Ratio of Each Component>

The blending amount of the polycarbodiimide (a) in the total amount of raw material components of the polycarbodiimide compound is preferably 10 to 90% by mass, more preferably 20 to 80% by mass, still more preferably 25 to 80% by mass, even more preferably 40 to 80% by weight, and further more preferably 45 to 75% by mass. When the blending amount is in the range of 10 to 90% by mass, the carbodiimide groups can be uniformly distributed in the cured product, and the carbodiimide groups can react with water molecules that have entered the cured product, thereby suppressing damage.

The blending amount of the polymer (b) in the total amount of raw material components of the polycarbodiimide compound is preferably 5 to 80% by mass, more preferably 15 to 75% by mass, still more preferably 18 to 70% by mass, even more preferably 18 to 58% by weight, and further more preferably 22 to 50% by mass. When the blending amount is in the range of 5 to 80% by mass, the carbodiimide groups can be uniformly distributed in the cured product, and the carbodiimide groups can react with water molecules that have entered the cured product, thereby suppressing damage.

The blending amount of the compound (c) in the total amount of raw material components of the polycarbodiimide compound is preferably 1 to 15% by mass. more preferably 2 to 10% by mass, and still more preferably 4 to 10% by mass. Within the range, it can react with the resin (D) having a (meth)acryloyl group, and thus the carbodiimide group can be uniformly distributed in the cured product, resulting in improved water resistance.

For the blending amount of the polymer (b) and the blending amount of the compound (c) in the total amount of raw material components of the polycarbodiimide compound, it is preferable that the polymer (b) is 5 to 80% by mass and the compound (c) is 1 to 15% by mass, more preferable that the polymer (b) is 15 to 75% by mass and the compound (c) is 2 to 10% by mass, still more preferable that the polymer (b) is 18 to 70% by mass and the compound (c) is 4 to 10% by mass, even more preferable that the polymer (b) is 18 to 58% by mass and the compound (c) is 4 to 10% by mass, and further more preferable that the polymer (b) is 22 to 50% by mass and the compound (c) is 4 to 10% by mass. Within in the range, the carbodiimide groups can be uniformly distributed in the cured product, and the carbodiimide groups can react with water molecules that have entered the cured product, thereby suppressing damage.

The blending amount of the polymer (b) with respect to 100 parts by mass of the polycarbodiimide (a) is preferably 10 to 300 parts by mass, more preferably 20 to 140 parts by mass, and still more preferably 30 to 110 parts by mass. When the blending amount of the polymer (b) is 10 parts by mass or more, the carbodiimide groups can be uniformly distributed in the cured product, and thus the carbodiimide groups can react with water molecules that have entered the cured product, thereby suppressing damage. In addition, when the blending amount of the polymer (b) is 300 parts by mass or less, the number of carbodiimide groups in the cured product is small, and damage caused by water molecules that have entered the cured product can be suppressed.

The blending amount of the compound (c) with respect to 100 parts by mass of the polycarbodiimide (a) is preferably 1 to 50 parts by mass, more preferably 3 to 30 parts by mass, and still more preferably 5 to 25 parts by mass. When the blending amount of the compound (c) is 1 part by mass or more, it can react with the resin (D) having a (meth)acryloyl group, and thus the carbodiimide group can be uniformly distributed in the cured product, resulting in improved water resistance. Moreover, when the blending amount of the compound (c) is 50 parts by mass or less, the cured product has high strength and is easy to handle.

The blending amount of the polymer (b) is preferably greater than the blending amount of the compound (c). When the blending amount of (b) is less than the blending amount of the compound (c), the carbodiimide groups cannot be uniformly distributed in the cured product, and the carbodiimide groups cannot react with water molecules that have entered the cured product, making it impossible to suppress damage.

The blending amount of the polymer (b) with respect to I part by mole of the polycarbodiimide (a) is preferably 0.1 to 2.0 parts by mole, more preferably 0.2 to 1.0 parts by mole, and still more preferably 0.4 to 0.6 parts by mole. When the blending amount is in the range of 0.1 to 2.0 parts by mole, the carbodiimide groups can be uniformly distributed in the cured product, and the carbodiimide groups can react with water molecules that have entered the cured product, thereby suppressing damage.

The blending amount of the compound (c) with respect to 1 part by mole of the polycarbodiimide (a) is preferably 0.1 to 2.1 parts by mole, more preferably 0.5 to 2.0 parts by mole, and still more preferably 1.0 to 1.2 parts by mole. Within the range, it can react with the resin (D) having a (meth)acryloyl group, and thus the carbodiimide group can be uniformly distributed in the cured product, resulting in improved water resistance.

### <Structure of Polycarbodiimide Compound>

The structure of the polycarbodiimide compound is not particularly limited as long as it has a structural unit derived from the polycarbodiimide (a) and a structural unit derived from the polymer (b), and it is preferable to further have a structural unit derived from the compound (c), and it is more preferable to consist only of a structural unit derived from the polycarbodiimide (a), a structural unit derived from the polymer (b), and a structural unit derived from the compound (c).

The total amount of the structural unit derived from the polycarbodiimide (a), the structural unit derived from the polymer (b), and the structural unit derived from the compound (c) in the polycarbodiimide compound is preferably 80% by mass or more, more preferably 90% by mass or more, still more preferably 95% by mass or more, and even more preferably 100% by mass.

Examples of the structure of the polycarbodiimide compound include polycarbodiimide compounds represented by the following formula (1) or the formula (2), and preferably a polycarbodiimide compound represented by formula (1).

C-y-A-x-B-x-A-y-C (1)

C-y-A-x-B (2)

In the formula (1) and the formula (2),
A is a residue obtained by removing the isocyanate groups at both ends from the polycarbodiimide (a),
B is a residue obtained by removing two functional groups that are capable of reacting with isocyanate groups from the polymer (b),
C is a residue obtained by removing one functional group that is capable of reacting with an isocyanate group from the compound (c),
x is a bond formed between one isocyanate group of the polycarbodiimide (a) and one of the functional groups that are capable of reacting with an isocyanate group of the polymer (b),
y is a bond formed between one isocyanate group of the polycarbodiimide (a) and one of the functional groups that are capable of reacting with an isocyanate group of the compound (c).

With the structure, it becomes easy to be compatible with, and also possible to react with the resin (D) having a (meth)acryloyl group, and thus the carbodiimide groups can be uniformly distributed in the cured product, resulting in improved water resistance.

### <Physical Properties of Polycarbodiimide Compound>

The NCN equivalent (chemical formula weight per mole of carbodiimide group) of the polycarbodiimide compound is preferably 200 to 1,000, more preferably 250 to 800, still more preferably 300 to 600, and even more preferably 320 to 600. When the NCN equivalent is 200 or more and 1,000 or less, it becomes easy to be compatible with the resin (D) having a (meth)acryloyl group, and the carbodiimide groups derived from the polycarbodiimide compound become uniformly present in the cured product. Therefore, the carbodiimide group reacts with water molecules that have entered the cured product, thereby producing an excellent effect of inhibiting the entered water molecules from deteriorating the cured product.

The NCN equivalent can be calculated by the method described in Examples.

### <Method for Producing Polycarbodiimide Compound>

The method for producing the polycarbodiimide compound is not particularly limited. For example, the polycarbodiimide compound can be produced by blending the polycarbodiimide (a), the polymer (b), and, if necessary, the compound (c), at the aforementioned blending ratio, and heating and stirring.

The polycarbodiimide compound can be produced preferably by heating the polycarbodiimide (a) in advance, adding the polymer (b) and the compound (c) to the heated polycarbodiimide (a), and heating and stirring.

The heating temperature of the polycarbodiimide (a) is preferably 90 to 120° C., more preferably 100 to 115° C., and even more preferably 105 to 115° C.

When adding the polymer (b) and the compound (c) to the polycarbodiimide (a) and heating and stirring, the heating temperature is preferably 80 to 120° C., more preferably 90 to 110° C., and still more preferably 90 to 104° C., and the heating and stirring time is preferably 1 to 10 hours, and more preferably 3 to 8 hours. When the heating temperature is 80° C. or higher, a reaction product can be rapidly produced, and when the heating temperature is 120° C. or lower, polymerization of the compound (c) can be prevented.

For example, the polycarbodiimide compound can be suitably produced by any of the following methods (1) to (6).
(1) Reacting the polycarbodiimide (a) and the polymer (b) at 120° C. or lower.
(2) Reacting the polycarbodiimide (a), the polymer (b), and the compound (c) at 120° C. or lower.
(3) Reacting the polycarbodiimide (a) and the polymer (b) in a solvent.
(4) Reacting the polycarbodiimide (a), the polymer (b), and the compound (c) in a solvent.
(5) Reacting the polycarbodiimide (a) and the polymer (b) in a solvent at 120° C. or lower.
(6) Reacting the polycarbodiimide (a), the polymer (b), and the compound (c) in a solvent at 120° C. or lower.

In addition, in the above (1) to (6), the reaction may be further carried out in the presence of a catalyst.

As the solvent, from the viewpoint of preventing the polymerization of the compound (c), a hydrocarbon solvent or a ketone solvent is preferable, and specifically, toluene, xylene, cyclohexanone, diisobutyl ketone, methyl isobutyl ketone, and methyl normal pentyl ketone are preferable. By using a solvent, the polycarbodiimide compound can be produced at a lower heating and stirring temperature. In the case of using a solvent, when adding the polymer (b) and the compound (c) to the polycarbodiimide (a) and heating and stirring, the heating temperature is preferably 40 to 120° C., more preferably 45 to 95° C., still more preferably 45 to 85° C., and even more preferably 50 to 80° C., and the heating and stirring time is preferably 1 to 36 hours, and more preferably 5 to 24 hours.

As the catalyst, from the viewpoint of promoting the reaction, tertiary amine compounds such as 1,4-diazabicyclo[2.2.2]octane and triethylenediamine: and organometallic compounds such as dibutyltin dilaurate and tetraoctyl titanate are preferable. By using a catalyst, the polycarbodiimide compound can be produced at a lower heating and stirring temperature. By using a solvent, the polycarbodiimide compound can be produced at a lower heating and stirring temperature. In the case of using a catalyst, when adding the polymer (b) and the compound (c) to the polycarbodiimide (a) and heating and stirring, the heating temperature is preferably 40 to 120° C., more preferably 45 to 95° C., still more preferably 45 to 85° C., and even more preferably 50 to 80° C., and the heating and stirring time is preferably I to 36 hours, and more preferably 5 to 24 hours.

### Resin Composition

The resin composition according to the present invention is a resin composition containing a resin (D) having a (meth)acryloyl group and the aforementioned polycarbodiimide compound.

The polycarbodiimide compound has an excellent effect of improving the water resistance of the resin (D) having a (meth)acryloyl group.

Although the reason is unclear, it is presumed to be as follows. That is, a moiety derived from the polymer (b) facilitates the compatibility with the resin (D) having a (meth)acryloyl group, and therefore the polycarbodiimide compound can be uniformly distributed in the resin composition and a cured product thereof. In addition, a moiety derived from the compound (c) contributes to maintaining a uniform structure in which the polycarbodiimide compound and the resin (D) having a (meth)acryloyl group are made compatible with each other even under high temperature and humidity conditions. Moreover, the carbodiimide groups derived from the polycarbodiimide (a) react with water molecules that have entered the cured product, thereby making it possible to inhibit the entered water molecules from deteriorating the cured product.

The resin composition according to the present invention preferably further contains a radical polymerization initiator (E).

<Resin (D) having a (meth)acryloyl Group>

From the viewpoint of water resistance, the resin (D) having a (meth)acryloyl group preferably does not contain a hydrophilic group. Examples include acrylic resin (meth)acrylate, urethane (meth)acrylate, epoxy (meth)acrylate, polyester (meth)acrylate, polyphenylene ether (meth)acrylate, hexanediol di(meth)acrylate, neopentylglycol di(meth)acrylate, pentaerythritol di(meth)acrylate, trimethylolpropane tri(meth)acrylate, pentaerythritol tri(meth)acrylate, and dipentaerythritol hexa(meth)acrylate, and acrylic resin (meth)acrylate, epoxy (meth)acrylate, and polyphenylene ether (meth)acrylate are more preferable.

The resin (D) preferably has a methacryloyl group.

The weight-average molecular weight of the resin (D) is preferably 40 to 1,000,000, more preferably 200 to 10,000, and even more preferably 1000 to 5,000. When the weight-average molecular weight is 40 or more, pinholes caused by volatilization during heat curing can be suppressed, and when the weight-average molecular weight is 1,000,000 or less, excellent moldability and handling properties are achieved.

From the viewpoint of durability of the cured product, the number of (meth)acryloyl groups per molecule of the resin (D) is preferably 1 to 1,000, more preferably 1 to 10, still more preferably 1 to 5, and even more preferably 2.

### <Radical Polymerization Initiator (E)>

Examples of the radical polymerization initiator (E) include dialkyl monoperoxides such as dicumyl peroxide, di-t-butyl peroxide, and t-butylcumyl peroxide: diperoxides such as 2,5-dimethyl-2,5-di(t-butylperoxy)hexane, 2,5-dimethyl-2,5-di(t-butylperoxy)hexyne-3, bis(t-butyldioxyisopropyl)benzene, 1,1-bis(t-butylperoxy)-3,3,5-trimethylcyclohexane, and n-butyl-4,4-bis(t-butylperoxy)valerate: diacyl peroxides such as benzoyl peroxide, p-chlorobenzoyl peroxide, and 2,4-dichlorobenzoyl peroxide: monoacyl alkyl peroxides such as t-butyl peroxy benzoate: percarbonates such as t-butyl peroxy isopropyl carbonate: organic peroxides such as diacyl peroxides, for example, diacetyl peroxide and lauroyl peroxide: and organic azo polymerization initiators such as 2,2′-azobis(4-methoxy-2,4-dimethylvaleronitrile), 2,2′-azobis(2,4-dimethylvaleronitrile), 2,2′-azobisisobutyronitrile, and 2,2-azobis[2-(2-imidazolin-2-yl) propane]. One kind of these may be used singly, or two or more kinds thereof may be used in combination. Among these, organic azo-based polymerization initiators are preferred from the viewpoint of reactivity, and azobisisobutyronitrile is more preferred.

### <Crosslinking Auxiliary Agent>

The resin composition may contain a crosslinking auxiliary agent.

As the crosslinking auxiliary agent, a known crosslinking auxiliary agent can be used, and examples thereof include polyfunctional monomers such as trimethylolpropane trimethacrylate, trimethylolpropane triacrylate, trimellitic acid triallyl ester, 1,2,4-benzenetricarboxylic acid triallyl ester, triallyl isocyanurate, 1,6-hexanediol dimethacrylate, 1,9-nonanediol dimethacrylate, 1,10-decanediol dimethacrylate, polyethylene glycol dimethacrylate, ethylene glycol dimethacrylate, diethylene glycol dimethacrylate, triethylene glycol dimethacrylate, divinylbenzene, glycerol dimethacrylate, and 2-hydroxy-3-acryloyloxypropyl methacrylate: stannous chloride, ferric chloride, organic sulfonic acid, polychloroprene, and chlorosulfonated polyethylene. Among these, triallyl isocyanurate is preferred.

As the crosslinking auxiliary agent, one type may be used alone, or two or more types may be used in combination.

### <Other Components>

The resin composition according to the present invention may contain other components within a range that does not impair the effects of the present invention.

Examples of other components include resins such as epoxy resins, acrylic resins, urethane resins, and phenolic resins; inorganic fillers such as silica; and solvents such as toluene and cyclohexanone.

### <Content of Each Component>

The content of the resin (D) in the solid content of the resin composition according to the present invention is preferably 20 to 95% by mass, more preferably 60 to 95% by mass, and still more preferably 70 to 90% by mass. When the content is 20 to 95% by mass, the cured product of the resin composition has excellent water resistance.

The content of the polycarbodiimide compound in the solid content of the resin composition according to the present invention is preferably 0.1 to 75% by mass, more preferably 1 to 30% by mass, and even more preferably 5 to 15% by mass. When the content is 0.1 to 75% by mass, the cured product of the resin composition has excellent water resistance.

When the resin composition contains the radical polymerization initiator (E), the content of the radical polymerization initiator (E) in the solid content of the resin composition is preferably 0.1 to 10% by mass, more preferably 0.5 to 5% by mass, and even more preferably 1 to 4% by mass.

When the resin composition contains a crosslinking auxiliary agent, the content of the crosslinking auxiliary agent in the solid content of the resin composition is preferably 0.1 to 40% by mass, more preferably 0.5 to 10% by mass, and even more preferably 2 to 8% by mass.

The solid content concentration in the total amount of the resin composition according to the present invention is preferably 20 to 80% by mass, more preferably 30 to 70% by mass, and still more preferably 40 to 60% by mass. The solid content means the components excluding the solvent, and the solid content concentration in the total amount of the resin composition means the concentration of the components excluding the solvent (i.e., the solid content) in the total amount of the resin composition.

### <Method for Producing Resin Composition>

The method for producing the resin composition is not particularly limited. For example, the resin composition can be produced by blending and stirring the polycarbodiimide compound, the resin (D) having a (meth)acryloyl group, and, if necessary, the radical polymerization initiator (E), a crosslinking auxiliary agent, and other components in the amounts described above.

The stirring temperature is preferably 10 to 100° C., more preferably 15 to 80° C., and even more preferably 15 to 50° C.

The stirring time is preferably 0.5 to 48 hours, more preferably 1 to 48 hours, still more preferably 1 to 24 hours, and even more preferably 1 to 12 hours.

### Resin Cured Product

The resin cured product according to the present invention is a cured product of the resin composition according to the present invention.

Details of the resin composition are as described above.

The resin composition can be cured appropriately by heating. The heating temperature during heating can be appropriately selected depending on the composition of the resin composition: and it is preferably 100 to 250° C., more preferably 150 to 250° C., still more preferably 170 to 220° C., and even more preferably 180 to 200° C.

The heating time can also be appropriately selected depending on the composition of the resin composition: and it is preferably 0.5 to 50 hours, more preferably 1 to 20 hours, still more preferably 2 to 10 hours, and even more preferably 4 to 7 hours.

### EXAMPLES

Hereinafter, the present invention will be described in detail with reference to Examples, but the present invention is not limited thereto.

### Synthesis of Polycarbodiimide Compound

First, each polycarbodiimide compound to be used in the following Examples and Comparative Examples was synthesized.

### Raw Material Compound

The details of the raw material compounds used in the Synthesis Examples below are as follows. The molecular weight in the present specification is a calculated value or a catalog value.

### <Diisocyanate Compound>

HMDI: Dicyclohexylmethane-4,4′-diisocyanate (molecular weight 262.35, manufactured by Tokyo Chemical Industry Co., Ltd.)
IPDI: Isophorone diisocyanate (molecular weight 222.29, manufactured by Tokyo Chemical Industry Co., Ltd.)
TMXDI: Tetramethylxylylene diisocyanate (molecular weight 244.29, manufactured by Tokyo Chemical Industry Co., Ltd.)
MDI: 4,4′-diphenylmethane diisocyanate (molecular weight 250.25, manufactured by Tokyo Chemical Industry Co., Ltd.)

### <Carbodiimidization Catalyst>

3-methyl-1-phenyl-2-phosphorene-1-oxide (manufactured by Tokyo Chemical Industry Co., Ltd.)
   <Polymer (b)>
G1000: Hydroxyl-terminated polybutadiene (hydroxyl value 76, number average molecular weight 1476, manufactured by Nippon Soda Co., Ltd.)
G2000: Hydroxyl-terminated polybutadiene (hydroxyl value 50, number average molecular weight 2244, manufactured by Nippon Soda Co., Ltd.)
G3000: Hydroxyl-terminated polybutadiene (hydroxyl value 29, number average molecular weight 3868, manufactured by Nippon Soda Co., Ltd.)
GI1000: Hydrogenated hydroxyl-terminated polybutadiene (hydroxyl value 72, number average molecular weight 1558, manufactured by Nippon Soda Co., Ltd.)
GI2000: Hydrogenated hydroxyl-terminated polybutadiene (hydroxyl value 53, number average molecular weight 2117, manufactured by Nippon Soda Co., Ltd.)
GI3000: Hydrogenated hydroxyl-terminated polybutadiene (hydroxyl value 32, number average molecular weight 3506, manufactured by Nippon Soda Co., Ltd.)
polybd R-15HT: Hydroxyl-terminated poly butadiene (hydroxyl value 46.6, number average molecular weight 2408, manufactured by Idemitsu Kosan Co., Ltd.)
polybd R-45HT: Hydroxyl-terminated polybutadiene (hydroxyl value 103, number average molecular weight 1089, manufactured by Idemitsu Kosan Co., Ltd.)
Poly-ip: Hydroxyl-terminated polyisoprene (PipOH) (hydroxyl value 46.1, number average molecular weight 2434, manufactured by Idemitsu Kosan Co., Ltd.)
Epole: Hydrogenated hydroxyl-terminated polyisoprene (HPipOH) (hydroxyl value 50.5, number average molecular weight 2222, manufactured by Idemitsu Kosan Co., Ltd.)
   <Compound (c)>
4-HBA: 4-hydroxybutyl acrylate (molecular weight 144.17, manufactured by Tokyo

Chemical Industry Co., Ltd.)
2-HEMA: 2-hydroxyethyl methacrylate (molecular weight 130.14, manufactured by Tokyo Chemical Industry Co., Ltd.)
Light acrylate PE-3A: Pentaerythritol triacrylate (molecular weight 298.29, manufactured by Kyoeisha Chemical Co., Ltd.)
   <Compound (c′)>
1-butanol (molecular weight 74.12, manufactured by Tokyo Chemical Industry Co., Ltd.)
Cyclohexylamine (molecular weight 99.18, manufactured by Tokyo Chemical Industry Co., Ltd.)

### <Solvent>

Cyclohexanone (manufactured by Tokyo Chemical Industry Co., Ltd.)
Methyl isobutyl ketone (Tokyo Chemical Industry Co., Ltd.)
Diisobutyl ketone (Tokyo Chemical Industry Co., Ltd.)
Methyl normal pentyl ketone (Tokyo Chemical Industry Co., Ltd.)
Toluene (manufactured by Tokyo Chemical Industry Co., Ltd.)
Xylene (manufactured by Tokyo Chemical Industry Co., Ltd.)

### <Catalyst>

1,4-diazabicyclo[2.2.2]octane (Tokyo Chemical Industry Co., Ltd.)
Triethylenediamine (Tokyo Chemical Industry Co., Ltd.)

### Analysis Apparatus and Method

Each analysis in the Synthesis Examples below was performed using the following apparatus and method.

### <Infrared Absorption (IR) Spectrum>

Measuring apparatus: “FTIR-8200PC”, manufactured by Shimadzu Corporation

### <Degree of Polymerization>

The degree of polymerization of the carbodiimide group in the isocyanate-terminated polycarbodiimide was determined by potentiometric titration (apparatus used: automatic titration apparatus “COM-900” manufactured by Hiranuma Co., Ltd.). Specifically, a toluene solution of di-n-butylamine of known concentration was mixed with the isocyanate-terminated polycarbodiimide obtained by the carbodiimidization reaction to allow reaction between terminal isocyanate groups and the di-n-butylamine, and the remaining di-n-butylamine was neutralized by titration with a standard hydrochloric acid solution to calculate the remaining amount of isocyanate groups (terminal NCO content [mass %]). The degree of polymerization of the carbodiimide group was calculated from the terminal NCO content.

### <Number Average Molecular Weight>

The number average molecular weight was calculated using gel permeation chromatography (GPC method) in terms of standard polystyrene.

RI detector: RID-10A (manufactured by Shimadzu Corporation)

UV detector: SPD-20AV (manufactured by Shimadzu Corporation)

Developing solvent: tetrahydrofuran (THF)

### Synthesis Example 1-

200 g of HMDI and 1 g of a carbodiimide catalyst were put into a 0.3 L container equipped with a reflux tube and a stirrer, and stirred for 16 hours at 175° C. under a nitrogen stream to obtain an isocyanate-terminated polycarbodiimide (a1-1), which is a polymer of 4,4′-dicyclohexylmethane diisocyanate. An absorption peak due to a carbodiimide group was confirmed at a wavelength of approximately 2150 cm⁻¹ by IR spectrum measurement. A terminal NCO content of 6.21% by mass and a degree of polymerization of 5.0 were confirmed by potentiometric titration.

### Synthesis Examples 1-2 to 1-7, 2-1 to 2-2, 3-1 to 3-7 and Comparative Synthesis Example 1

Isocyanate-terminated polycarbodiimides (a1-2) to (a1-7), (a2-1) to (a2-2), (a3-1) to (a3-7), and isocyanate-terminated monocarbodiimide (a′-1) were obtained in the same manner as in the Synthesis Example 1-1 except that the type and blending amount of diisocyanate compounds, the blending amount of carbodiimidization catalysts, the stirring temperature, and the stirring time were as shown in Table 1.

The measurement results of the degree of polymerization and molecular weight of each of the obtained isocyanate-terminated polycarbodiimides and isocyanate-terminated monocarbodiimide are shown in Table 1.

### Example 1-1

39.0 g of the isocyanate-terminated polycarbodiimide (a1-1) obtained in Synthesis Example 1-1 was placed in a separate 0.3 L container equipped with a reflux tube and a stirrer, and heated to 110° C. To that, 55.8 g of G3000 (0.5 mol per mole of the isocyanate-terminated polycarbodiimide) as the polymer (b) and 4.6 g of 4-HBA (1.1 mol per mole of the isocyanate-terminated polycarbodiimide) as the compound (c) were added, and the mixture was allowed to react for 5 hours with heating and stirring at 100° C. to obtain a reaction product. After confirming that the absorption of the isocyanate group at a wavelength of 2200 to 2300 cm⁻¹ had disappeared by IR spectrum measurement of the reaction product, the reaction product was removed from the reaction container and cooled to room temperature (25° C.) to obtain a polycarbodiimide compound. (Since one molecule of the polycarbodiimide compound contains 2 mol of a structure derived from the polycarbodiimide (a) with a degree of polymerization of 5.0, the number of carbodiimide groups in one molecule of the polycarbodiimide compound is 10). The amount of the polymer (b) used was calculated based on the theoretical molecular weight of the polycarbodiimide compound. The theoretical molecular weight can be calculated from the hydroxyl value. In the case of a hydroxyl value of 29 mg KOH/g. 2000 (there are 2 mol of hydroxy groups in one molecule, and this is a value obtained by multiplying by 1000 to convert mg to g)×56.1 (formula weight of potassium hydroxide)÷29=3868.

Next, the polycarbodiimide compound, polyphenylene ether type methacrylate as the resin (D) having a (meth)acryloyl group (manufactured by Sabic, trade name “PPE SA9000”. weight-average molecular weight 1700, number of methacryloyl groups per molecule of resin: 2), triallyl isocyanurate as the crosslinking auxiliary agent, azobisisobutyronitrile as the radical polymerization initiator (E), and toluene as the solvent were added and blended in the blending amounts shown in Table 2, and stirred and mixed at 20° C. for 1 hour to obtain a resin composition with a solid content of 50% by mass.

The NCN equivalent (chemical formula weight per I mole of carbodiimide group) of the polycarbodiimide compound was calculated assuming that the molar ratio of a structure derived from the polycarbodiimide (a), a structure derived from the polymer (b), and a structure derived from the compound (c) in the polycarbodiimide compound was 1:0.5:1. The results are shown in Table 2.

### Examples 1-2 to 1-10, Examples 2-1 to 2-6, Examples 3-1 to 3-10, Examples 4-1 to 4-9, Comparative Examples 1-1 to 1-3, and Examples 5-1 to 5-6

A polycarbodiimide compound was obtained in the same manner as in Example 1-1. except that the types, blending amounts, and producing conditions of the polycarbodiimide (a). the polymer (b), the compound (c), and the compound (c′) were as shown in Tables 2 to 7. Next, the polycarbodiimide compound and the components shown in Tables 2 to 7 were blended in the blending amounts shown in Tables 2 to 7, and the mixture was stirred and mixed under the producing conditions shown in Tables 2 to 7 to obtain a resin composition.

### Comparative Example 1-4

In a 0.3 L container equipped with a reflux tube and a stirrer, 56.6 g of MDI, 39.3 g of G1000, and 7.7 g of 4-HBA were placed, and stirred at 50° C. for 3 hours under a nitrogen stream. After adding 1 g of a carbodiimidization catalyst, the mixture was stirred at 80° C. for 5 hours, and the target carbodiimide compound was obtained by confirming that the absorption of the isocyanate group at a wavelength of 2200 to 2300 cm⁻¹ had disappeared by IR spectrum measurement (since the molar ratio of the diisocyanate structure, the structure derived from the polymer (b), and the structure derived from the compound (c) was 8:1: 2, the polycarbodiimide compound theoretically contains 2 moles of the polycarbodiimide (a) with a degree of polymerization of 3.0 in one molecule. The number of carbodiimide groups in one molecule of the polycarbodiimide compound is 6).

In addition, since the mass is theoretically reduced to 49.1 g due to decarboxylation in the process of carbodiimidization of 56.6 g of MDI with a degree of polymerization of 3, for convenience the theoretical mass % is recorded as 49.1 in Table 6.

Next, the polycarbodiimide compound and the components shown in Table 6 were blended in the blending amounts shown in Table 6, and the mixture was stirred and mixed under the producing conditions shown in Table 6 to obtain a resin composition.

### Example 6-1

In a separate 0.3 L container equipped with a reflux tube and a stirrer, 64.0 g of the isocyanate-terminated polycarbodiimide (a1-4) obtained in Synthesis Example 1-4 was placed, and 100 g of cyclohexanone was further added as a solvent and heated to 50° C. After visually confirming that the mixture was homogeneous, 30.1 g of G1000 (0.5 mol per mole of the isocyanate-terminated polycarbodiimide) as the polymer (b), 6.5 g of 4-HBA (1.1 mol per mole of the isocyanate-terminated polycarbodiimide) as the compound (c), 0.32 g of 1,4-diazabicyclo[2,2,2]octane as a catalyst were added thereto, and the mixture was allowed to react for 5 hours with heating and stirring at 50° C. to obtain a reaction product. After confirming that the absorption of the isocyanate group at a wavelength of 2200 to 2300 cm⁻¹ had disappeared by IR spectrum measurement of the reaction product, the reaction product was removed from the reaction container and cooled to room temperature (25° C.) to obtain a poly carbodiimide compound.

Next, the polycarbodiimide compound and the components shown in Table 8 were blended in the blending amounts shown in Table 8, and the mixture was stirred and mixed under the producing conditions shown in Table 8 to obtain a resin composition.

### Examples 6-2 to 6-12

A polycarbodiimide compound was obtained in the same manner as in Example 6-1, except that the types, blending amounts, and producing conditions of the polycarbodiimide (a), the polymer (b), the compound (c), the solvent, and the catalyst were as shown in Table 8.

Next, the polycarbodiimide compound and the components shown in Table 8 were blended in the blending amounts shown in Table 8, and the mixture was stirred and mixed under the producing conditions shown in Table 8 to obtain a resin composition.

### Evaluation of Resin Composition

A wet heat test (accelerated evaluation of water resistance) was conducted as follows for each resin composition obtained in the above Examples and Comparative Examples. The results are shown in Tables 2 to 8.

### Wet Heat Test (Accelerated Evaluation of Water Resistance)

The resin composition was applied to an aluminum plate to a thickness of 50 μm and dried for 1 hour in a vacuum dryer set at 60° C. The temperature was then raised to 190° C. and by heating for 5 hours, a cured product was obtained.

The resulting cured product and distilled water were placed in a stainless steel pressure vessel and left to stand in a dryer set at 120° C. for 6 hours. Thereafter, the cured product was removed and visually evaluated based on the following evaluation criteria. The results are shown in Tables 2 to 8.

### <Evaluation Criteria>

5: No damage to the cured product
4: Slight air bubbles in the cured product
3: Peeling occurs over 20% or more but less than 50% of the area of the cured product
2: Peeling occurs over 50% or more but less than 80% of the area of the cured product
1: Peeling occurs over 80% or more of the area of the cured product

TABLE 1

| | | | | Synthesis Example | | | | | | | | |
|---|---|---|---|---|---|---|---|---|---|---|---|---|
| | | | | 1-1 | 1-2 | 1-3 | 1-4 | 1-5 | 1-6 | 1-7 | 2-1 | 2-2 |
| Polycarbodiimide (*1) | | | | a1-1 | a1-2 | a1-3 | a1-4 | a1-5 | a1-6 | a1-7 | a2-1 | a2-2 |
| Raw | Diisocyanate | HMDI | g | 200 | 200 | 200 | 200 | 200 | 200 | 200 | | |
| material | compound | IPDI | g | | | | | | | | 200 | 200 |
| etc. | | TMXDI | g | | | | | | | | | |
| | | MDI | g | | | | | | | | | |
| | Carbodiimidization | 3-methyl-1-phenyl-2- | g | 1 | 1 | 1 | 1 | 1 | 1 | 1 | 2 | 2 |
| | catalyst | phosphorene-1-oxide | | | | | | | | | | |
| Producing | Stirring temperature | | ° C. | 175 | 175 | 175 | 175 | 175 | 175 | 175 | 170 | 170 |
| condition | Stirring time | | hr | 16 | 9 | 11 | 18 | 22 | 24 | 20 | 7 | 9 |
| Physical | Degree of polymerization | | — | 5 | 2 | 3 | 6 | 9 | 12 | 8 | 3 | 5 |
| property | Theoretical molecular weight | | — | 1352 | 698 | 916 | 1570 | 2224 | 2878 | 2006 | 756 | 1112 |
| value | | | | | | | | | | | | |

| | | | | | | | | | | | Comparative |
|---|---|---|---|---|---|---|---|---|---|---|---|
| | | | | | | | | | | | Synthesis |
| | | | | Synthesis Example | | | | | | | Example |
| | | | | 3-1 | 3-2 | 3-3 | 3-4 | 3-5 | 3-6 | 3-7 | 1 |
| Polycarbodiimide (*1) | | | | a3-1 | a3-2 | a3-3 | a3-4 | a3-5 | a3-6 | a3-7 | a′-1 |
| Raw | Diisocyanate | HMDI | g | | | | | | | | 200 |
| material | compound | IPDI | g | | | | | | | | |
| etc. | | TMXDI | g | 200 | 200 | 200 | 200 | 200 | 200 | 200 | |
| | | MDI | g | | | | | | | | |
| | Carbodiimidization | 3-methyl-1-phenyl-2- | g | 4 | 4 | 4 | 4 | 4 | 4 | 4 | 1 |
| | catalyst | phosphorene-1-oxide | | | | | | | | | |
| Producing | Stirring temperature | | ° C. | 170 | 170 | 170 | 170 | 170 | 170 | 170 | 185 |
| condition | Stirring time | | hr | 9 | 12 | 14 | 15 | 16 | 17 | 18 | 4 |
| Physical | Degree of polymerization | | — | 2 | 3 | 5 | 6 | 8 | 9 | 13 | 1 |
| property | Theoretical molecular weight | | — | 644 | 844 | 1244 | 1444 | 1844 | 2044 | 2844 | 480 |
| value | | | | | | | | | | | |

(*1): Only the Comparative Synthesis Example 1 used the monocarbodiimide (a′-1).

TABLE 2

| | | | | Examples | | | | | | | | | |
|---|---|---|---|---|---|---|---|---|---|---|---|---|---|
| | | | | 1-1 | 1-2 | 1-3 | 1-4 | 1-5 | 1-6 | 1-7 | 1-8 | 1-9 | 1-10 |
| Polycarbodiimide | Polycarbodiimide | a1-1 (raw material: HMDI, degree | g | 39.0 | | | | | | | | | |
| Compound | (a) | of polymerization: 5, theoretical | | | | | | | | | | | |
| | | molecular weight 1352) | | | | | | | | | | | |
| | | a1-2 (raw material: HMDI, degree | g | | 35.0 | | | | 44.0 | | | | |
| | | of polymerization: 2, theoretical | | | | | | | | | | | |
| | | molecular weight 698) | | | | | | | | | | | |
| | | a1-3 (raw material: HMDI, degree | g | | | 42.0 | | | | 51.0 | | | |
| | | of polymerization: 3, theoretical | | | | | | | | | | | |
| | | molecular weight 916) | | | | | | | | | | | |
| | | a1-4 (raw material: HMDI, degree | g | | | | 55.0 | | | | 64.0 | | |
| | | of polymerization: 6, theoretical | | | | | | | | | | | |
| | | molecular weight 1570) | | | | | | | | | | | |
| | | a1-5 (raw material: HMDI, degree | g | | | | | 63.0 | | | | 71.0 | |
| | | of polymerization: 9, theoretical | | | | | | | | | | | |
| | | molecular weight 2224) | | | | | | | | | | | |
| | | a1-6 (raw material: HMDI, degree | g | | | | | | | | | | 76.0 |
| | | of polymerization: 12, theoretical | | | | | | | | | | | |
| | | molecular weight 2878) | | | | | | | | | | | |
| | | a1-7 (raw material: HMDI, degree | g | | | | | | | | | | |
| | | of polymerization: 8, theoretical | | | | | | | | | | | |
| | | molecular weight 2006) | | | | | | | | | | | |
| | Polymer (b) | G1000 (number average | g | | | | | | 46.5 | 41.1 | 30.1 | 23.6 | 19.5 |
| | | molecular weight 1476) | | | | | | | | | | | |
| | | G2000 (number average | g | | 56.3 | 51.4 | 39.3 | 31.8 | | | | | |
| | | molecular weight 2244) | | | | | | | | | | | |
| | | G3000 (number average | g | 55.8 | | | | | | | | | |
| | | molecular weight 3868) | | | | | | | | | | | |
| | | GI1000 (number average | g | | | | | | | | | | |
| | | molecular weight 1558) | | | | | | | | | | | |
| | | GI2000 (number average | g | | | | | | | | | | |
| | | molecular weight 2117) | | | | | | | | | | | |
| | | GI3000 (number average | g | | | | | | | | | | |
| | | molecular weight 3506) | | | | | | | | | | | |
| | | polybd R-15HT (number average | g | | | | | | | | | | |
| | | molecular weight 2408) | | | | | | | | | | | |
| | | polybd R-45HT (number average | g | | | | | | | | | | |
| | | molecular weight 1089) | | | | | | | | | | | |
| | | Poly-ip (number average | g | | | | | | | | | | |
| | | molecular weight 2434) | | | | | | | | | | | |
| | | Epole (number average molecular | g | | | | | | | | | | |
| | | weight 2222) | | | | | | | | | | | |
| | Compound (c) | 4-HBA | g | 4.6 | 7.9 | 7.3 | 5.5 | 4.5 | 10.0 | 8.8 | 6.5 | 5.1 | 4.2 |
| | | 2-HEMA | g | | | | | | | | | | |
| | | Light acrylate PE-3A | g | | | | | | | | | | |

| | | | | Examples | | | | | | | | | |
|---|---|---|---|---|---|---|---|---|---|---|---|---|---|
| | | | | 1-1 | 1-2 | 1-3 | 1-4 | 1-5 | 1-6 | 1-7 | 1-8 | 1-9 | 1-10 |
| Polycarbodiimide | Compound (c′) | 1-butanol | g | | | | | | | | | | |
| Compound | | Cyclohexylamine | g | | | | | | | | | | |
| | Molar ratio | Polycarbodiimide (a) | Parts by | 1 | 1 | 1 | 1 | 1 | 1 | 1 | 1 | 1 | 1 |
| | | | mole | | | | | | | | | | |
| | | Polymer (b) | Parts by | 0.5 | 0.5 | 0.5 | 0.5 | 0.5 | 0.5 | 0.5 | 0.5 | 0.5 | 0.5 |
| | | | mole | | | | | | | | | | |
| | | Compound (c) or | Parts by | 1.1 | 1.1 | 1.1 | 1.1 | 1.1 | 1.1 | 1.1 | 1.1 | 1.1 | 1.1 |
| | | compound (c′) | mole | | | | | | | | | | |
| | Mass ratio | Parts by mass of (b) with | Parts by | 143 | 161 | 122 | 71 | 50 | 106 | 81 | 47 | 33 | 26 |
| | | respect to 100 parts by | mass | | | | | | | | | | |
| | | mass of (a) | | | | | | | | | | | |
| | Producing | Heating temperature | ° C. | 110 | 110 | 110 | 110 | 110 | 110 | 110 | 110 | 110 | 110 |
| | condition | Stirring temperature | ° C. | 100 | 100 | 100 | 100 | 100 | 100 | 100 | 100 | 100 | 110 |
| | | Stirring time | hr | 5 | 5 | 5 | 5 | 5 | 5 | 5 | 5 | 5 | 5 |
| | Physical | NCN equivalent | — | 686 | 982 | 727 | 473 | 388 | 790 | 599 | 409 | 345 | 313 |
| | property value | | | | | | | | | | | | |
| Resin | Polycarbodiimide Compound | | Parts by | 10 | 10 | 10 | 10 | 10 | 10 | 10 | 10 | 10 | 10 |
| Composition | | | mass | | | | | | | | | | |
| | Resin (D) | Polyphenylene ether type | Parts by | 85 | 85 | 85 | 85 | 85 | 85 | 85 | 85 | 85 | 85 |
| | having a | methacrylate | mass | | | | | | | | | | |
| | (meth)acryloyl | | | | | | | | | | | | |
| | group | | | | | | | | | | | | |
| | Crosslinking | Triallyl isocyanurate | Parts by | 5 | 5 | 5 | 5 | 5 | 5 | 5 | 5 | 5 | 5 |
| | auxiliary agent | | mass | | | | | | | | | | |
| | Radical polymerization | Azobisisobutyronitrile | Parts by | 2 | 2 | 2 | 2 | 2 | 2 | 2 | 2 | 2 | 2 |
| | initiator (E) | | mass | | | | | | | | | | |
| | Other | G1000 | Parts by | | | | | | | | | | |
| | | | mass | | | | | | | | | | |
| | Solvent | Toluene | Parts by | 102 | 102 | 102 | 102 | 102 | 102 | 102 | 102 | 102 | 102 |
| | | | mass | | | | | | | | | | |
| | Solid content concentration | | % by | 50 | 50 | 50 | 50 | 50 | 50 | 50 | 50 | 50 | 50 |
| | | | mass | | | | | | | | | | |
| | Producing | Stirring temperature | ° C. | 20 | 20 | 20 | 20 | 20 | 20 | 20 | 20 | 20 | 20 |
| | condition | Stirring time | hr | 1 | 1 | 1 | 1 | 1 | 1 | 1 | 1 | 1 | 1 |
| | Evaluation | Wet heat test | — | 3 | 3 | 4 | 5 | 5 | 4 | 5 | 5 | 5 | 4 |

TABLE 3

| | | | | Examples | | | | | |
|---|---|---|---|---|---|---|---|---|---|
| | | | | 2-1 | 2-2 | 2-3 | 2-4 | 2-5 | 2-6 |
| Polycarbodiimide | Polycarbodiimide | a2-1 (raw material: IPDI, degree | g | 27.0 | | 37.0 | | 46.0 | |
| Compound | (a) | of polymerization: 3, theoretical | | | | | | | |
| | | molecular weight 756) | | | | | | | |
| | | a2-2 (raw material: IPDI, degree | g | | 35.0 | | 46.0 | | 55.0 |
| | | of polymerization: 5, theoretical | | | | | | | |
| | | molecular weight 1112) | | | | | | | |
| | Polymer (b) | G1000 (number average | g | | | | | 44.9 | 36.5 |
| | | molecular weight 1476) | | | | | | | |
| | | G2000 (number average | g | | | 54.9 | 46.4 | | |
| | | molecular weight 2244) | | | | | | | |
| | | G3000 (number average | g | 69.1 | 60.9 | | | | |
| | | molecular weight 3868) | | | | | | | |
| | | GI1000 (number average | g | | | | | | |
| | | molecular weight 1558) | | | | | | | |
| | | GI2000 (number average | g | | | | | | |
| | | molecular weight 2117) | | | | | | | |
| | | GI3000 (number average | g | | | | | | |
| | | molecular weight 3506) | | | | | | | |
| | | polybd R-15HT (number | g | | | | | | |
| | | average molecular weight 2408) | | | | | | | |
| | | polybd R-45HT (number | g | | | | | | |
| | | average molecular weight 1089) | | | | | | | |
| | | Poly-ip (number average | g | | | | | | |
| | | molecular weight 2434) | | | | | | | |
| | | Epole (number average | g | | | | | | |
| | | molecular weight 2222) | | | | | | | |
| | Compound (c) | 4-HBA | g | 5.7 | 5.0 | 7.8 | 6.6 | 9.6 | 7.8 |
| | | 2-HEMA | g | | | | | | |
| | | Light acrylate PE-3A | g | | | | | | |
| | Compound (c′) | 1-butanol | g | | | | | | |
| | | Cyclohexylamine | g | | | | | | |

| | | | | Examples | | | | | |
|---|---|---|---|---|---|---|---|---|---|
| | | | | 2-1 | 2-2 | 2-3 | 2-4 | 2-5 | 2-6 |
| Polycarbodiimide | Molar ratio | Polycarbodiimide (a) | Parts by | 1 | 1 | 1 | 1 | 1 | 1 |
| Compound | | | mole | | | | | | |
| | | Polymer (b) | Parts by | 0.5 | 0.5 | 0.5 | 0.5 | 0.5 | 0.5 |
| | | | mole | | | | | | |
| | | Compound (c) or | Parts by | 1.1 | 1.1 | 1.1 | 1.1 | 1.1 | 1.1 |
| | | compound (c′) | mole | | | | | | |
| | Mass ratio | Parts by mass of (b) | Parts by | 256 | 174 | 148 | 101 | 98 | 66 |
| | | with respect to 100 | mass | | | | | | |
| | | parts by mass of (a) | | | | | | | |
| | Producing | Heating temperature | ° C. | 110 | 110 | 110 | 110 | 110 | 110 |
| | condition | Stirring temperature | ° C. | 100 | 100 | 100 | 100 | 100 | 100 |
| | | Stirring time | hr | 3 | 3 | 3 | 3 | 3 | 3 |
| | Physical | NCN equivalent | — | 945 | 638 | 674 | 476 | 546 | 399 |
| | property value | | | | | | | | |
| Resin | Polycarbodiimide Compound | | Parts by | 10 | 10 | 10 | 10 | 10 | 10 |
| Composition | | | mass | | | | | | |
| | Resin (D) | Polyphenylene ether | Parts by | 85 | 85 | 85 | 85 | 85 | 85 |
| | having a | type methacrylate | mass | | | | | | |
| | (meth)acryloyl | | | | | | | | |
| | group | | | | | | | | |
| | Crosslinking | Triallyl isocyanurate | Parts by | 5 | 5 | 5 | 5 | 5 | 5 |
| | auxiliary agent | | mass | | | | | | |
| | Radical | Azobisisobutyronitrile | Parts by | 2 | 2 | 2 | 2 | 2 | 2 |
| | polymerization | | mass | | | | | | |
| | initiator (E) | | | | | | | | |
| | Other | G1000 | Parts by | | | | | | |
| | | | mass | | | | | | |
| | Solvent | Toluene | Parts by | 102 | 102 | 102 | 102 | 102 | 102 |
| | | | mass | | | | | | |
| | Solid content concentration | | % by | 50 | 50 | 50 | 50 | 50 | 50 |
| | | | mass | | | | | | |
| | Producing | Stirring temperature | ° C. | 20 | 20 | 20 | 20 | 20 | 20 |
| | condition | Stirring time | hr | 1 | 1 | 1 | 1 | 1 | 1 |
| | Evaluation | Wet heat test | — | 3 | 3 | 3 | 5 | 5 | 5 |

TABLE 4

| | | | | Examples | | | | | | | | | |
|---|---|---|---|---|---|---|---|---|---|---|---|---|---|
| | | | | 3-1 | 3-2 | 3-3 | 3-4 | 3-5 | 3-6 | 3-7 | 3-8 | 3-9 | 3-10 |
| Polycarbodiimide | Polycarbodiimide | a3-1 (raw material: TMXDI, | g | | | | | | 42.0 | | | | |
| Compound | (a) | degree of polymerization: 2, | | | | | | | | | | | |
| | | theoretical molecular weight 644) | | | | | | | | | | | |
| | | a3-2 (raw material: TMXDI, | g | | | | 40.0 | | | 48.0 | | | |
| | | degree of polymerization: 3, | | | | | | | | | | | |
| | | theoretical molecular weight 844) | | | | | | | | | | | |
| | | a3-3 (raw material: TMXDI, | g | 37.0 | | | | 49.0 | | | 58.0 | | |
| | | degree of polymerization: 5, | | | | | | | | | | | |
| | | theoretical molecular weight | | | | | | | | | | | |
| | | 1244) | | | | | | | | | | | |
| | | a3-4 (raw material: TMXDI, | g | | 41.0 | | | | | | | | |
| | | degree of polymerization: 6, | | | | | | | | | | | |
| | | theoretical molecular weight | | | | | | | | | | | |
| | | 1444) | | | | | | | | | | | |
| | | a3-5 (raw material: TMXDI, | g | | | 47.0 | | | | | | | |
| | | degree of polymerization: 8, | | | | | | | | | | | |
| | | theoretical molecular weight | | | | | | | | | | | |
| | | 1844) | | | | | | | | | | | |
| | | a3-6 (raw material: TMXDI, | g | | | | | | | | | 70.0 | |
| | | degree of polymerization: 9, | | | | | | | | | | | |
| | | theoretical molecular weight | | | | | | | | | | | |
| | | 2044) | | | | | | | | | | | |
| | | a3-7 (raw material: TMXDI, | g | | | | | | | | | | 76.0 |
| | | degree of polymerization: 13, | | | | | | | | | | | |
| | | theoretical molecular weight | | | | | | | | | | | |
| | | 2844) | | | | | | | | | | | |
| | Polymer (b) | G1000 (number average | g | | | | | | 48.1 | 42 | 34.4 | 25.3 | 19.7 |
| | | molecular weight 1476) | | | | | | | | | | | |
| | | G2000 (number average | g | | | | 53.2 | 44.2 | | | | | |
| | | molecular weight 2244) | | | | | | | | | | | |
| | | G3000 (number average | g | 57.5 | 54.9 | 49.3 | | | | | | | |
| | | molecular weight 3868) | | | | | | | | | | | |
| | | GI1000 (number average | g | | | | | | | | | | |
| | | molecular weight 1558) | | | | | | | | | | | |
| | | GI2000 (number average | g | | | | | | | | | | |
| | | molecular weight 2117) | | | | | | | | | | | |
| | | GI3000 (number average | g | | | | | | | | | | |
| | | molecular weight 3506) | | | | | | | | | | | |
| | | polybd R-15HT (number average | g | | | | | | | | | | |
| | | molecular weight 2408) | | | | | | | | | | | |
| | | polybd R-45HT (number average | g | | | | | | | | | | |
| | | molecular weight 1089) | | | | | | | | | | | |
| | | Poly-ip (number average | g | | | | | | | | | | |
| | | molecular weight 2434) | | | | | | | | | | | |
| | | Epole (number average molecular | g | | | | | | | | | | |
| | | weight 2222) | | | | | | | | | | | |
| | Compound (c) | 4-HBA | g | 4.7 | 4.5 | 4.0 | 7.5 | 6.2 | 10.3 | 9.0 | 7.4 | 5.4 | 4.2 |
| | | 2-HEMA | g | | | | | | | | | | |
| | | Light acrylate PE-3A | g | | | | | | | | | | |

| | | | | Examples | | | | | | | | | |
|---|---|---|---|---|---|---|---|---|---|---|---|---|---|
| | | | | 3-1 | 3-2 | 3-3 | 3-4 | 3-5 | 3-6 | 3-7 | 3-8 | 3-9 | 3-10 |
| Polycarbodiimide | Compound (c′) | 1-butanol | g | | | | | | | | | | |
| Compound | | Cyclohexylamine | g | | | | | | | | | | |
| | Molar ratio | Polycarbodiimide (a) | Parts by | 1 | 1 | 1 | 1 | 1 | 1 | 1 | 1 | 1 | 1 |
| | | | mole | | | | | | | | | | |
| | | Polymer (b) | Parts by | 0.5 | 0.5 | 0.5 | 0.5 | 0.5 | 0.5 | 0.5 | 0.5 | 0.5 | 0.5 |
| | | | mole | | | | | | | | | | |
| | | Compound (c) or | Parts by | 1.1 | 1.1 | 1.1 | 1.1 | 1.1 | 1.1 | 1.1 | 1.1 | 1.1 | 1.1 |
| | | compound (c′) | mole | | | | | | | | | | |
| | Mass ratio | Parts by mass of (b) | Parts by | 156 | 134 | 105 | 133 | 90 | 115 | 87 | 59 | 36 | 26 |
| | | with respect to 100 | mass | | | | | | | | | | |
| | | parts by mass of (a) | | | | | | | | | | | |
| | Producing | Heating temperature | ° C. | 110 | 110 | 110 | 110 | 110 | 110 | 110 | 110 | 110 | 110 |
| | condition | Stirring temperature | ° C. | 100 | 100 | 100 | 100 | 100 | 100 | 100 | 100 | 100 | 100 |
| | | Stirring time | hr | 7 | 7 | 7 | 7 | 7 | 7 | 7 | 7 | 7 | 7 |
| | Physical | NCN equivalent | — | 664 | 587 | 490 | 703 | 502 | 763 | 575 | 425 | 325 | 287 |
| | property value | | | | | | | | | | | | |
| Resin | Polycarbodiimide Compound | | Parts by | 10 | 10 | 10 | 10 | 10 | 10 | 10 | 10 | 10 | 10 |
| Composition | | | mass | | | | | | | | | | |
| | Resin (D) | Polyphenylene ether | Parts by | 85 | 85 | 85 | 85 | 85 | 85 | 85 | 85 | 85 | 85 |
| | having a | type methacrylate | mass | | | | | | | | | | |
| | (meth)acryloyl | | | | | | | | | | | | |
| | group | | | | | | | | | | | | |
| | Crosslinking | Triallyl isocyanurate | Parts by | 5 | 5 | 5 | 5 | 5 | 5 | 5 | 5 | 5 | 5 |
| | auxiliary agent | | mass | | | | | | | | | | |
| | Radical | Azobisisobutyronitrile | Parts by | 2 | 2 | 2 | 2 | 2 | 2 | 2 | 2 | 2 | 2 |
| | polymerization | | mass | | | | | | | | | | |
| | initiator (E) | | | | | | | | | | | | |
| | Other | G1000 | Parts by | | | | | | | | | | |
| | | | mass | | | | | | | | | | |
| | Solvent | Toluene | Parts by | 102 | 102 | 102 | 102 | 102 | 102 | 102 | 102 | 102 | 102 |
| | | | mass | | | | | | | | | | |
| | Solid content concentration | | % by | 50 | 50 | 50 | 50 | 50 | 50 | 50 | 50 | 50 | 50 |
| | | | mass | | | | | | | | | | |
| | Producing | Stirring temperature | ° C. | 20 | 20 | 20 | 20 | 20 | 20 | 20 | 20 | 20 | 20 |
| | condition | Stirring time | hr | 1 | 1 | 1 | 1 | 1 | 1 | 1 | 1 | 1 | 1 |
| | Evaluation | Wet heat test | — | 3 | 4 | 5 | 4 | 5 | 4 | 5 | 5 | 5 | 4 |

TABLE 5

| | | | | Examples | | | | | | | | |
|---|---|---|---|---|---|---|---|---|---|---|---|---|
| | | | | 4-1 | 4-2 | 4-3 | 4-4 | 4-5 | 4-6 | 4-7 | 4-8 | 4-9 |
| Polycarbodiimide | Polycarbodiimide | a1-1 (raw material: HMDI, | g | 59.0 | 59.0 | 50.0 | 66.0 | 50.0 | 52.0 | 62.0 | 62.0 | |
| Compound | (a) | degree of polymerization: 5, | | | | | | | | | | |
| | | theoretical molecular weight | | | | | | | | | | |
| | | 1352) | | | | | | | | | | |
| | | a1-2 (raw material: HMDI, | g | | | | | | | | | |
| | | degree of polymerization: 2, | | | | | | | | | | |
| | | theoretical molecular weight 698) | | | | | | | | | | |
| | | a1-3 (raw material: HMDI, | g | | | | | | | | | |
| | | degree of polymerization: 3, | | | | | | | | | | |
| | | theoretical molecular weight 916) | | | | | | | | | | |
| | | a1-4 (raw material: HMDI, | g | | | | | | | | | |
| | | degree of polymerization: 6, | | | | | | | | | | |
| | | theoretical molecular weight | | | | | | | | | | |
| | | 1570) | | | | | | | | | | |
| | | a1-5 (raw material: HMDI, | g | | | | | | | | | |
| | | degree of polymerization: 9, | | | | | | | | | | |
| | | theoretical molecular weight | | | | | | | | | | |
| | | 2224) | | | | | | | | | | |
| | | a1-6 (raw material: HMDI, | g | | | | | | | | | |
| | | degree of polymerization: 12, | | | | | | | | | | |
| | | theoretical molecular weight | | | | | | | | | | |
| | | 2878) | | | | | | | | | | |
| | | a1-7 (raw material: HMDI, | g | | | | | | | | | 70.0 |
| | | degree of polymerization: 8, | | | | | | | | | | |
| | | theoretical molecular weight | | | | | | | | | | |
| | | 2006) | | | | | | | | | | |
| | Polymer (b) | G1000 (number average | g | | | | | | | 33.9 | 33.9 | 25.8 |
| | | molecular weight 1476) | | | | | | | | | | |
| | | G2000 (number average | g | | | | | | | | | |
| | | molecular weight 2244) | | | | | | | | | | |
| | | G3000 (number average | g | | | | | | | | | |
| | | molecular weight 3868) | | | | | | | | | | |
| | | GI1000 (number average | g | 34.0 | 34.0 | | | | | | | |
| | | molecular weight 1558) | | | | | | | | | | |
| | | GI2000 (number average | g | | | | | | | | | |
| | | molecular weight 2117) | | | | | | | | | | |
| | | GI3000 (number average | g | | | | | | | | | |
| | | molecular weight 3506) | | | | | | | | | | |
| | | polybd R-15HT (number average | g | | | 44.5 | | | | | | |
| | | molecular weight 2408) | | | | | | | | | | |
| | | polybd R-45HT (number average | g | | | | 26.6 | | | | | |
| | | molecular weight 1089) | | | | | | | | | | |
| | | Poly-ip (number average | g | | | | | 45 | | | | |
| | | molecular weight 2434) | | | | | | | | | | |
| | | Epole (number average molecular | g | | | | | | 42.7 | | | |
| | | weight 2222) | | | | | | | | | | |
| | Compound (c) | 4-HBA | g | | | 5.9 | 7.7 | 5.9 | 6.1 | | | 5.5 |
| | | 2-HEMA | g | 6.2 | | | | | | | | |
| | | Light acrylate PE-3A | g | | 6.2 | | | | | | | |

| | | | | Examples | | | | | | | | |
|---|---|---|---|---|---|---|---|---|---|---|---|---|
| | | | | 4-1 | 4-2 | 4-3 | 4-4 | 4-5 | 4-6 | 4-7 | 4-8 | 4-9 |
| Polycarbodiimide | Compound (c′) | 1-butanol | g | | | | | | | 3.7 | | |
| Compound | | Cyclohexylamine | g | | | | | | | | 4.6 | |
| | Molar ratio | Polycarbodiimide (a) | Parts by | 1 | 1 | 1 | 1 | 1 | 1 | 1 | 1 | 1 |
| | | | mole | | | | | | | | | |
| | | Polymer (b) | Parts by | 0.5 | 0.5 | 0.5 | 0.5 | 0.5 | 0.5 | 0.5 | 0.5 | 0.5 |
| | | | mole | | | | | | | | | |
| | | Compound (c) or | Parts by | 1.1 | 1.1 | 1.1 | 1.1 | 1.1 | 1.1 | 1.1 | 1.1 | 1.1 |
| | | compound (c′) | mole | | | | | | | | | |
| | Mass ratio | Parts by mass of (b) | Parts by | 58 | 58 | 89 | 40 | 90 | 82 | 55 | 55 | 37 |
| | | with respect to 100 | mass | | | | | | | | | |
| | | parts by mass of (a) | | | | | | | | | | |
| | Producing | Heating temperature | ° C. | 110 | 110 | 110 | 110 | 110 | 110 | 110 | 110 | 110 |
| | condition | Stirring temperature | ° C. | 100 | 100 | 100 | 100 | 100 | 100 | 100 | 100 | 100 |
| | | Stirring time | hr | 5 | 5 | 5 | 5 | 5 | 5 | 5 | 5 | 5 |
| | Physical | NCN equivalent | — | 452.23 | 485.83 | 540 | 408 | 540 | 521 | 432 | 438 | 361 |
| | property value | | | | | | | | | | | |
| Resin | Polycarbodiimide Compound | | Parts by | 10 | 10 | 10 | 10 | 10 | 10 | 10 | 10 | 10 |
| Composition | | | mass | | | | | | | | | |
| | Resin (D) | Polyphenylene ether | Parts by | 85 | 85 | 85 | 85 | 85 | 85 | 85 | 85 | 85 |
| | having a | type methacrylate | mass | | | | | | | | | |
| | (meth)acryloyl | | | | | | | | | | | |
| | group | | | | | | | | | | | |
| | Crosslinking | Triallyl isocyanurate | Parts by | 5 | 5 | 5 | 5 | 5 | 5 | 5 | 5 | 5 |
| | auxiliary agent | | mass | | | | | | | | | |
| | Radical | Azobisisobutyronitrile | Parts by | 2 | 2 | 2 | 2 | 2 | 2 | 2 | 2 | 2 |
| | polymerization | | mass | | | | | | | | | |
| | initiator (E) | | | | | | | | | | | |
| | Other | G1000 | Parts by | | | | | | | | | |
| | | | mass | | | | | | | | | |
| | Solvent | Toluene | Parts by | 102 | 102 | 102 | 102 | 102 | 102 | 102 | 102 | 102 |
| | | | mass | | | | | | | | | |
| | Solid content concentration | | % by | 50 | 50 | 50 | 50 | 50 | 50 | 50 | 50 | 50 |
| | | | mass | | | | | | | | | |
| | Producing | Stirring temperature | ° C. | 20 | 20 | 20 | 20 | 20 | 20 | 20 | 20 | 20 |
| | condition | Stirring time | hr | 1 | 1 | 1 | 1 | 1 | 1 | 1 | 1 | 1 |
| | Evaluation | Wet heat test | — | 5 | 5 | 5 | 5 | 5 | 5 | 5 | 5 | 5 |

TABLE 6

| | | | | Comparative Examples | | | |
|---|---|---|---|---|---|---|---|
| | | | | 1-1 | 1-2 | 1-3 | 1-4 |
| Polycarbodiimide | Polycarbodiimide | a1-1 (raw material: HMDI, degree of | g | | | | |
| Compound | (a) | polymerization: 5, theoretical | | | | | |
| | | molecular weight 1352) | | | | | |
| | | a1-2 (raw material: HMDI, degree of | g | | | | |
| | | polymerization: 2, theoretical | | | | | |
| | | molecular weight 698) | | | | | |
| | | a1-3 (raw material: HMDI, degree of | g | | | | |
| | | polymerization: 3, theoretical | | | | | |
| | | molecular weight 916) | | | | | |
| | | a1-4 (raw material: HMDI, degree of | g | 85.0 | 85.0 | | |
| | | polymerization: 6, theoretical | | | | | |
| | | molecular weight 1570) | | | | | |
| | | a1-5 (raw material: HMDI, degree of | g | | | | |
| | | polymerization: 9, theoretical | | | | | |
| | | molecular weight 2224) | | | | | |
| | | a1-6 (raw material: HMDI, degree of | g | | | | |
| | | polymerization: 12, theoretical | | | | | |
| | | molecular weight 2878) | | | | | |
| | | a1-7 (raw material: HMDI, degree of | g | | | | |
| | | polymerization: 8, theoretical | | | | | |
| | | molecular weight 2006) | | | | | |
| | Monocarbodiimide | a′-1 (raw material: HMDI, degree of | g | | | 35.0 | |
| | | polymerization: 1, molecular weight: | | | | | |
| | | 480) | | | | | |
| | Polycarbodiimide | a′-2 (raw material: MDI, degree of | g | | | | 49.1 |
| | (a′) | polymerization: 3, molecular weight: | | | | | |
| | | 868) | | | | | |
| | Polymer (b) | G1000 (number average molecular | g | | | 53.8 | 39.3 |
| | | weight 1476) | | | | | |
| | | G2000 (number average molecular | g | | | | |
| | | weight 2244) | | | | | |
| | | G3000 (number average molecular | g | | | | |
| | | weight 3868) | | | | | |
| | | GI1000 (number average molecular | g | | | | |
| | | weight 1558) | | | | | |
| | | GI2000 (number average molecular | g | | | | |
| | | weight 2117) | | | | | |
| | | GI3000 (number average molecular | g | | | | |
| | | weight 3506) | | | | | |
| | | polybd R-15HT (number average | g | | | | |
| | | molecular weight 2408) | | | | | |
| | | polybd R-45HT (number average | g | | | | |
| | | molecular weight 1089) | | | | | |
| | | Poly-ip (number average molecular | g | | | | |
| | | weight 2434) | | | | | |
| | | Epole (number average molecular | g | | | | |
| | | weight 2222) | | | | | |

| | | | | Comparative Examples | | | |
|---|---|---|---|---|---|---|---|
| | | | | 1-1 | 1-2 | 1-3 | 1-4 |
| Polycarbodiimide | Compound (c) | 4-HBA | g | 15.6 | 15.6 | 11.6 | 7.7 |
| Compound | | 2-HEMA | g | | | | |
| | | Light acrylate PE-3A | g | | | | |
| | Compound (c′) | 1-butanol | g | | | | |
| | | Cyclohexylamine | g | | | | |
| | Molar ratio | Polycarbodiimide (a) | Parts by | 1 | 1 | 1 | 1 |
| | | | mole | | | | |
| | | Polymer (b) | Parts by | | | 0.5 | 0.5 |
| | | | mole | | | | |
| | | Compound (c) or compound (c′) | Parts by | 1.1 | 1.1 | 1.1 | 1.1 |
| | | | mole | | | | |
| | Mass ratio | Parts by mass of (b) with respect | Parts by | 0 | 0 | 154 | 80 |
| | | to 100 parts by mass of (a) | mass | | | | |
| | Producing | Heating temperature | ° C. | 110 | 110 | 110 | 50° C.→80° C. |
| | condition | Stirring temperature | ° C. | 100 | 100 | 100 | 50° C.→80° C. |
| | | Stirring time | hr | 5 | 5 | 5 | 3 + 5 |
| | Physical | NCN equivalent | — | 310 | 310 | 1362 | 583 |
| | property value | | | | | | |
| Resin | Polycarbodiimide Compound | | Parts by | 10 | 10 | 10 | 10 |
| Composition | | | mass | | | | |
| | Resin (D) | Polyphenylene ether type | Parts by | 85 | 85 | 85 | 85 |
| | having a | methacrylate | mass | | | | |
| | (meth)acryloyl | | | | | | |
| | group | | | | | | |
| | Crosslinking | Triallyl isocyanurate | Parts by | 5 | 5 | 5 | 5 |
| | auxiliary agent | | mass | | | | |
| | Radical | Azobisisobutyronitrile | Parts by | 2 | 2 | 2 | 2 |
| | polymerization | | mass | | | | |
| | initiator (E) | | | | | | |
| | Other | G1000 | Parts by | | 3 | | |
| | | | mass | | | | |
| | Solvent | Toluene | Parts by | 102 | 105 | 102 | 102 |
| | | | mass | | | | |
| | Solid content concentration | | % by | 50 | 50 | 50 | 50 |
| | | | mass | | | | |
| | Producing | Stirring temperature | ° C. | 20 | 20 | 20 | 20 |
| | condition | Stirring time | hr | 1 | 1 | 1 | 1 |
| | Evaluation | Wet heat test | — | 1 | 1 | 1 | 1 |

TABLE 7

| | | | | Examples | | | | | |
|---|---|---|---|---|---|---|---|---|---|
| | | | | 5-1 | 5-2 | 5-3 | 5-4 | 5-5 | 5-6 |
| Polycarbodiimide | Polycarbodiimide | a1-1 (raw material: HMDI, degree | g | | | | | | |
| Compound | (a) | of polymerization: 5, theoretical | | | | | | | |
| | | molecular weight 1352) | | | | | | | |
| | | a1-2 (raw material: HMDI, degree | g | | | | | | |
| | | of polymerization: 2, theoretical | | | | | | | |
| | | molecular weight 698) | | | | | | | |
| | | a1-3 (raw material: HMDI, degree | g | | | | | | |
| | | of polymerization: 3, theoretical | | | | | | | |
| | | molecular weight 916) | | | | | | | |
| | | a1-4 (raw material: HMDI, degree | g | | | | | | |
| | | of polymerization: 6, theoretical | | | | | | | |
| | | molecular weight 1570) | | | | | | | |
| | | a1-5 (raw material: HMDI, degree | g | 71.0 | 71.0 | 71.0 | 71.0 | 71.0 | 71.0 |
| | | of polymerization: 9, theoretical | | | | | | | |
| | | molecular weight 2224) | | | | | | | |
| | | a1-6 (raw material: HMDI, degree | g | | | | | | |
| | | of polymerization: 12, theoretical | | | | | | | |
| | | molecular weight 2878) | | | | | | | |
| | | a1-7 (raw material: HMDI, degree | g | | | | | | |
| | | of polymerization: 8, theoretical | | | | | | | |
| | | molecular weight 2006) | | | | | | | |
| | Polymer (b) | G1000 (number average molecular | g | 23.6 | 23.6 | 23.6 | 23.6 | 23.6 | 23.6 |
| | | weight 1476) | | | | | | | |
| | | G2000 (number average molecular | g | | | | | | |
| | | weight 2244) | | | | | | | |
| | | G3000 (number average molecular | g | | | | | | |
| | | weight 3868) | | | | | | | |
| | | GI1000 (number average | g | | | | | | |
| | | molecular weight 1558) | | | | | | | |
| | | GI2000 (number average | g | | | | | | |
| | | molecular weight 2117) | | | | | | | |
| | | GI3000 (number average | g | | | | | | |
| | | molecular weight 3506) | | | | | | | |
| | | polybd R-15HT (number average | g | | | | | | |
| | | molecular weight 2408) | | | | | | | |
| | | polybd R-45HT (number average | g | | | | | | |
| | | molecular weight 1089) | | | | | | | |
| | | Poly-ip (number average | g | | | | | | |
| | | molecular weight 2434) | | | | | | | |
| | | Epole (number average molecular | g | | | | | | |
| | | weight 2222) | | | | | | | |
| | Compound (c) | 4-HBA | g | 5.1 | 5.1 | 5.1 | 5.1 | 5.1 | 5.1 |
| | | 2-HEMA | g | | | | | | |
| | | Light acrylate PE-3A | g | | | | | | |

| | | | | Examples | | | | | |
|---|---|---|---|---|---|---|---|---|---|
| | | | | 5-1 | 5-2 | 5-3 | 5-4 | 5-5 | 5-6 |
| Polycarbodiimide | Compound (c′) | 1-butanol | g | | | | | | |
| Compound | | Cyclohexylamine | g | | | | | | |
| | Molar ratio | Polycarbodiimide (a) | Parts by | 1 | 1 | 1 | 1 | 1 | 1 |
| | | | mole | | | | | | |
| | | Polymer (b) | Parts by | 0.5 | 0.5 | 0.5 | 0.5 | 0.5 | 0.5 |
| | | | mole | | | | | | |
| | | Compound (c) or | Parts by | 1.1 | 1.1 | 1.1 | 1.1 | 1.1 | 1.1 |
| | | compound (c′) | mole | | | | | | |
| | Mass ratio | Parts by mass of (b) with | Parts by | 33 | 33 | 33 | 33 | 33 | 33 |
| | | respect to 100 parts by | mass | | | | | | |
| | | mass of (a) | | | | | | | |
| | Producing | Heating temperature | ° C. | 110 | 110 | 110 | 110 | 110 | 110 |
| | condition | Stirring temperature | ° C. | 100 | 100 | 100 | 100 | 100 | 100 |
| | | Stirring time | hr | 5 | 5 | 5 | 5 | 5 | 5 |
| | Physical | NCN equivalent | — | 345 | 345 | 345 | 345 | 345 | 345 |
| | property value | | | | | | | | |
| Resin | Polycarbodiimide Compound | | Parts by | 1 | 5 | 20 | 70 | 10 | 10 |
| Composition | | | mass | | | | | | |
| | Resin (D) | Polyphenylene ether type | Parts by | 94.5 | 90 | 75 | 25 | 85 | 90 |
| | having a | methacrylate | mass | | | | | | |
| | (meth)acryloyl | | | | | | | | |
| | group | | | | | | | | |
| | Crosslinking | Triallyl isocyanurate | Parts by | 5 | 5 | 5 | 5 | 5 | 5 |
| | auxiliary agent | | mass | | | | | | |
| | Radical | Azobisisobutyronitrile | Parts by | 2 | 2 | 2 | 2 | 0.2 | 5 |
| | polymerization | | mass | | | | | | |
| | initiator (E) | | | | | | | | |
| | Other | G1000 | Parts by | | | | | | |
| | | | mass | | | | | | |
| | Solvent | Toluene | Parts by | 103 | 102 | 102 | 102 | 100 | 110 |
| | | | mass | | | | | | |
| | Solid content concentration | | % by | 50 | 50 | 50 | 50 | 50 | 50 |
| | | | mass | | | | | | |
| | Producing | Stirring temperature | ° C. | 20 | 20 | 20 | 20 | 20 | 20 |
| | condition | Stirring time | hr | 1 | 1 | 1 | 1 | 1 | 1 |
| | Evaluation | Wet heat test | — | 3 | 4 | 4 | 3 | 4 | 5 |

TABLE 8

| | | | | Examples | | | | | |
|---|---|---|---|---|---|---|---|---|---|
| | | | | 6-1 | 6-2 | 6-3 | 6-4 | 6-5 | 6-6 |
| Polycarbodiimide | Polycarbodiimide | a1-1 (raw material: HMDI, | g | | | | | | |
| Compound | (a) | degree of polymerization: 5, | | | | | | | |
| | | theoretical molecular weight | | | | | | | |
| | | 1352) | | | | | | | |
| | | a1-2 (raw material: HMDI, | g | | | | | | |
| | | degree of polymerization: 2, | | | | | | | |
| | | theoretical molecular weight | | | | | | | |
| | | 698) | | | | | | | |
| | | a1-3 (raw material: HMDI, | g | | | | | | |
| | | degree of polymerization: 3, | | | | | | | |
| | | theoretical molecular weight | | | | | | | |
| | | 916) | | | | | | | |
| | | a1-4 (raw material: HMDI, | g | 64.0 | 64.0 | 64.0 | 64.0 | 64.0 | 64.0 |
| | | degree of polymerization: 6, | | | | | | | |
| | | theoretical molecular weight | | | | | | | |
| | | 1570) | | | | | | | |
| | | a1-5 (raw material: HMDI, | g | | | | | | |
| | | degree of polymerization: 9, | | | | | | | |
| | | theoretical molecular weight | | | | | | | |
| | | 2224) | | | | | | | |
| | | a1-6 (raw material: HMDI, | g | | | | | | |
| | | degree of polymerization: | | | | | | | |
| | | 12, theoretical molecular | | | | | | | |
| | | weight 2878) | | | | | | | |
| | | a1-7 (raw material: HMDI, | g | | | | | | |
| | | degree of polymerization: 8, | | | | | | | |
| | | theoretical molecular weight | | | | | | | |
| | | 2006) | | | | | | | |
| | Polymer (b) | G1000 (number average | g | 30.1 | 30.1 | 30.1 | 30.1 | 30.1 | 30.1 |
| | | molecular weight 1476) | | | | | | | |
| | | G2000 (number average | g | | | | | | |
| | | molecular weight 2244) | | | | | | | |
| | | G3000 (number average | g | | | | | | |
| | | molecular weight 3868) | | | | | | | |
| | | GI1000 (number average | g | | | | | | |
| | | molecular weight 1558) | | | | | | | |
| | | GI2000 (number average | g | | | | | | |
| | | molecular weight 2117) | | | | | | | |
| | | GI3000 (number average | g | | | | | | |
| | | molecular weight 3506) | | | | | | | |
| | | polybd R-15HT (number | g | | | | | | |
| | | average molecular weight | | | | | | | |
| | | 2408) | | | | | | | |
| | | polybd R-45HT (number | g | | | | | | |
| | | average molecular weight | | | | | | | |
| | | 1089) | | | | | | | |
| | | Poly-ip (number average | g | | | | | | |
| | | molecular weight 2434) | | | | | | | |
| | | Epole (number average | g | | | | | | |
| | | molecular weight 2222) | | | | | | | |
| | Compound (c) | 4-HBA | g | 6.5 | 6.5 | 6.5 | 6.5 | 6.5 | 6.5 |
| | | 2-HEMA | g | | | | | | |
| | | Light acrylate PE-3A | g | | | | | | |
| | Compound (c′) | 1-butanol | g | | | | | | |
| | | Cyclohexylamine | g | | | | | | |
| | | | | Examples | | | | | |
| | | | | 6-7 | 6-8 | 6-9 | 6-10 | 6-11 | 6-12 |
| Polycarbodiimide | Polycarbodiimide | a1-1 (raw material: HMDI, | g | | | | | | |
| Compound | (a) | degree of polymerization: 5, | | | | | | | |
| | | theoretical molecular weight | | | | | | | |
| | | 1352) | | | | | | | |
| | | a1-2 (raw material: HMDI, | g | | | | | | |
| | | degree of polymerization: 2, | | | | | | | |
| | | theoretical molecular weight | | | | | | | |
| | | 698) | | | | | | | |
| | | a1-3 (raw material: HMDI, | g | | | | | | |
| | | degree of polymerization: 3, | | | | | | | |
| | | theoretical molecular weight | | | | | | | |
| | | 916) | | | | | | | |
| | | degree of polymerization: 6, | g | 64.0 | 64.0 | 64.0 | 64.0 | 64.0 | 64.0 |
| | | a1-4 (raw material: HMDI, | | | | | | | |
| | | theoretical molecular weight | | | | | | | |
| | | 1570) | | | | | | | |
| | | a1-5 (raw material: HMDI, | g | | | | | | |
| | | degree of polymerization: 9, | | | | | | | |
| | | theoretical molecular weight | | | | | | | |
| | | 2224) | | | | | | | |
| | | a1-6 (raw material: HMDI, | g | | | | | | |
| | | degree of polymerization: | | | | | | | |
| | | 12, theoretical molecular | | | | | | | |
| | | weight 2878) | | | | | | | |
| | | a1-7 (raw material: HMDI, | g | | | | | | |
| | | degree of polymerization: 8, | | | | | | | |
| | | theoretical molecular weight | | | | | | | |
| | | 2006) | | | | | | | |
| | Polymer (b) | G1000 (number average | g | 30.1 | 30.1 | 30.1 | 30.1 | 30.1 | 30.1 |
| | | molecular weight 1476) | | | | | | | |
| | | G2000 (number average | g | | | | | | |
| | | molecular weight 2244) | | | | | | | |
| | | G3000 (number average | g | | | | | | |
| | | molecular weight 3868) | | | | | | | |
| | | GI1000 (number average | g | | | | | | |
| | | molecular weight 1558) | | | | | | | |
| | | GI2000 (number average | g | | | | | | |
| | | molecular weight 2117) | | | | | | | |
| | | GI3000 (number average | g | | | | | | |
| | | molecular weight 3506) | | | | | | | |
| | | polybd R-15HT (number | g | | | | | | |
| | | average molecular weight | | | | | | | |
| | | 2408) | | | | | | | |
| | | polybd R-45HT (number | g | | | | | | |
| | | average molecular weight | | | | | | | |
| | | 1089) | | | | | | | |
| | | Poly-ip (number average | g | | | | | | |
| | | molecular weight 2434) | | | | | | | |
| | | Epole (number average | g | | | | | | |
| | | molecular weight 2222) | | | | | | | |
| | Compound (c) | 4-HBA | g | 6.5 | 6.5 | 6.5 | 6.5 | 6.5 | 6.5 |
| | | 2-HEMA | g | | | | | | |
| | | Light acrylate PE-3A | g | | | | | | |
| | Compound (c′) | 1-butanol | g | | | | | | |
| | | Cyclohexylamine | g | | | | | | |

| | | | | Examples | | | | | |
|---|---|---|---|---|---|---|---|---|---|
| | | | | 6-1 | 6-2 | 6-3 | 6-4 | 6-5 | 6-6 |
| Polycarbodiimide | Molar ratio | Polycarbodiimide (a) | Parts by | 1 | 1 | 1 | 1 | 1 | 1 |
| Compound | | | mole | | | | | | |
| | | Polymer (b) | Parts by | 0.5 | 0.5 | 0.5 | 0.5 | 0.5 | 0.5 |
| | | | mole | | | | | | |
| | | Compound (c) or | Parts by | 1.1 | 1.1 | 1.1 | 1.1 | 1.1 | 1.1 |
| | | compound (c′) | mole | | | | | | |
| | Mass ratio | Parts by mass of (b) | Parts by | 47 | 47 | 47 | 47 | 47 | 47 |
| | | with respect to 100 | mass | | | | | | |
| | | parts by mass of (a) | | | | | | | |
| | Solvent | Cyclohexanone | g | 100 | 100 | | | | |
| | | Methyl isobutyl | g | | | 100 | 100 | | |
| | | ketone | | | | | | | |
| | | Diisobutyl ketone | g | | | | | 100 | 100 |
| | | Methyl normal pentyl | g | | | | | | |
| | | ketone | | | | | | | |
| | | Toluene | g | | | | | | |
| | | Xylene | g | | | | | | |
| | Catalyst | 1,4- | g | 0.32 | | 0.32 | | 0.32 | |
| | | diazabicyclo[2.2.2]octane | | | | | | | |
| | | Triethylenediamine | g | | 0.64 | | 0.64 | | 0.64 |
| | Producing | Heating temperature | ° C. | 50 | 80 | 50 | 80 | 50 | 80 |
| | condition | Stirring temperature | ° C. | 50 | 80 | 50 | 80 | 50 | 80 |
| | | Stirring time | hr | 5 | 24 | 5 | 24 | 5 | 24 |
| | Physical | NCN equivalent | — | 409 | 409 | 409 | 409 | 409 | 409 |
| | property value | | | | | | | | |
| Resin | Polycarbodiimide Compound | | Parts by | 10 | 10 | 10 | 10 | 10 | 10 |
| Composition | | | mass | | | | | | |
| | Resin (D) | Polyphenylene ether | Parts by | 85 | 85 | 85 | 85 | 85 | 85 |
| | having a | type methacrylate | mass | | | | | | |
| | (meth)acryloyl | | | | | | | | |
| | group | | | | | | | | |
| | Crosslinking | Triallyl isocyanurate | Parts by | 5 | 5 | 5 | 5 | 5 | 5 |
| | auxiliary agent | | mass | | | | | | |
| | Radical | Azobisisobutyronitrile | Parts by | 2 | 2 | 2 | 2 | 2 | 2 |
| | polymerization | | mass | | | | | | |
| | initiator (E) | | | | | | | | |
| | Other | G1000 | Parts by | | | | | | |
| | | | mass | | | | | | |
| | Solvent | Toluene | Parts by | 102 | 102 | 102 | 102 | 102 | 102 |
| | | | mass | | | | | | |
| | Solid content concentration | | % by | 50 | 50 | 50 | 50 | 50 | 50 |
| | | | mass | | | | | | |
| | Producing | Stirring temperature | ° C. | 20 | 20 | 20 | 20 | 20 | 20 |
| | condition | Stirring time | hr | 1 | 1 | 1 | 1 | 1 | 1 |
| | Evaluation | Wet heat test | — | 4 | 4 | 4 | 4 | 4 | 4 |
| | | | | Examples | | | | | |
| | | | | 6-7 | 6-8 | 6-9 | 6-10 | 6-11 | 6-12 |
| Polycarbodiimide | Molar ratio | Polycarbodiimide (a) | Parts by | 1 | 1 | 1 | 1 | 1 | 1 |
| Compound | | | mole | | | | | | |
| | | Polymer (b) | Parts by | 0.5 | 0.5 | 0.5 | 0.5 | 0.5 | 0.5 |
| | | | mole | | | | | | |
| | | Compound (c) or | Parts by | 1.1 | 1.1 | 1.1 | 1.1 | 1.1 | 1.1 |
| | | compound (c′) | mole | | | | | | |
| | Mass ratio | Parts by mass of (b) | Parts by | 47 | 47 | 47 | 47 | 47 | 47 |
| | | with respect to 100 | mass | | | | | | |
| | | parts by mass of (a) | | | | | | | |
| | Solvent | Cyclohexanone | g | | | | | | |
| | | Methyl isobutyl | g | | | | | | |
| | | ketone | | | | | | | |
| | | Diisobutyl ketone | g | | | | | | |
| | | Methyl normal pentyl | g | 100 | 100 | | | | |
| | | ketone | | | | | | | |
| | | Toluene | g | | | 100 | 100 | | |
| | | Xylene | g | | | | | 100 | 100 |
| | Catalyst | 1,4- | g | 0.32 | | 0.32 | | 0.32 | |
| | | diazabicyclo[2.2.2]octane | | | | | | | |
| | | Triethylenediamine | g | | 0.64 | | 0.64 | | 0.64 |
| | Producing | Heating temperature | ° C. | 50 | 80 | 50 | 80 | 50 | 80 |
| | condition | Stirring temperature | ° C. | 50 | 80 | 50 | 80 | 50 | 80 |
| | | Stirring time | hr | 5 | 24 | 5 | 24 | 5 | 24 |
| | Physical | NCN equivalent | — | 409 | 409 | 409 | 409 | 409 | 409 |
| | property value | | | | | | | | |
| Resin | Polycarbodiimide Compound | | Parts by | 10 | 10 | 10 | 10 | 10 | 10 |
| Composition | | | mass | | | | | | |
| | Resin (D) | Polyphenylene ether | Parts by | 85 | 85 | 85 | 85 | 85 | 85 |
| | having a | type methacrylate | mass | | | | | | |
| | (meth)acryloyl | | | | | | | | |
| | group | | | | | | | | |
| | Crosslinking | Triallyl isocyanurate | Parts by | 5 | 5 | 5 | 5 | 5 | 5 |
| | auxiliary agent | | mass | | | | | | |
| | Radical | Azobisisobutyronitrile | Parts by | 2 | 2 | 2 | 2 | 2 | 2 |
| | polymerization | | mass | | | | | | |
| | initiator (E) | | | | | | | | |
| | Other | G1000 | Parts by | | | | | | |
| | | | mass | | | | | | |
| | Solvent | Toluene | Parts by | 102 | 102 | 102 | 102 | 102 | 102 |
| | | | mass | | | | | | |
| | Solid content concentration | | % by | 50 | 50 | 50 | 50 | 50 | 50 |
| | | | mass | | | | | | |
| | Producing | Stirring temperature | ° C. | 20 | 20 | 20 | 20 | 20 | 20 |
| | condition | Stirring time | hr | 1 | 1 | 1 | 1 | 1 | 1 |
| | Evaluation | Wet heat test | — | 4 | 4 | 5 | 5 | 5 | 5 |

The resin compositions according to each Example had a result of 3 or more in the wet heat test, and were excellent in water resistance.

On the other hand, the resin compositions according to Comparative Examples 1-1 and 1-2 had a result of 1 in the wet heat test and poor water resistance, because the polycarbodiimide compound did not have a structure derived from the polymer (b). Furthermore, the resin composition according to Comparative Example 1-3 contained a monocarbodiimide compound instead of a polycarbodiimide compound, and therefore the result of the wet heat test was 1, and the water resistance was poor. In addition, the resin composition of Comparative Example 1-4 had a result of 1 in the wet heat test and poor water resistance because the diisocyanate constituting the polycarbodiimide compound was an aromatic diisocyanate.

In Examples 6-1 to 6-12, the polycarbodiimide compound was produced by reacting the polycarbodiimide (a), the polymer (b), and the compound (c) in the presence of a solvent and a catalyst, and therefore the polycarbodiimide compound was successfully produced even though the reaction was carried out at a relatively low heating temperature and stirring temperature of 50 to 80° C. In addition, the resulting resin composition had excellent water resistance.

1. A polycarbodiimide compound, which is a reaction product of
a polycarbodiimide (a) having an isocyanate group at both ends, obtained by polymerizing at least one selected from aliphatic diisocyanate and alicyclic diisocyanate,
a polymer (b) that is a polymer of at least one selected from butadiene and isoprene or a hydrogenated product thereof and has a functional group capable of reacting with an isocyanate group and
a compound (c) having a (meth)acryloyl group and a functional group that is capable of reacting with an isocyanate group.

2. The polycarbodiimide compound according to claim 1, wherein the polycarbodiimide (a) has a degree of polymerization of 2 to 20.

3. The polycarbodiimide compound according to claim 1, wherein the polycarbodiimide (a) has a theoretical molecular weight of 400 to 8,000.

4. The polycarbodiimide compound according to claim 1, wherein the at least one selected from aliphatic diisocyanate and alicyclic diisocyanate is at least one selected from dicyclohexylmethane-4,4′-diisocyanate, isophorone diisocyanate, and tetramethylxylylene diisocyanate.

5. The polycarbodiimide compound according to claim 1, wherein the polymer (b) is blended in an amount of 10 to 300 parts by mass based on 100 parts by mass of the polycarbodiimide (a).

6. The polycarbodiimide compound according to claim 1, wherein the polymer (b) has a number average molecular weight of 500 to 5,000.

7. The polycarbodiimide compound according to claim 1, wherein the functional group capable of reacting with the isocyanate group of the polymer (b) is at least one selected from an isocyanate group, a hydroxy group, an amino group, and a carboxy group.

8. (canceled)

9. The polycarbodiimide compound according to claim 1, wherein the polycarbodiimide (a) is blended in an amount of 20 to 80% by mass in a total blending amount of 100% by mass of the polycarbodiimide (a), the polymer (b), and the compound (c).

10. The polycarbodiimide compound according to claim 1, wherein the functional group capable of reacting with the isocyanate group of the compound (c) is at least one selected from an isocyanate group, a hydroxy group, an amino group, and a carboxy group.

11. The polycarbodiimide compound according to claim 1, wherein the compound (c) is monohydroxyalkyl (meth)acrylate.

12. A resin composition comprising a resin (D) having a (meth)acryloyl group and the polycarbodiimide compound according to claim 1.

13. The resin composition according to claim 12, further comprising a radical polymerization initiator (E).

14. A resin cured product, which is a cured product of the resin composition according to claim 12.

15. (canceled)

16. A method for producing a polycarbodiimide compound, which is a reaction product of
a polycarbodiimide (a) having an isocyanate group at both ends, obtained by polymerizing at least one selected from aliphatic diisocyanate and alicyclic diisocyanate,
a polymer (b) that is a polymer of at least one selected from butadiene and isoprene or a hydrogenated product thereof and has a functional group capable of reacting with an isocyanate group, and
a compound (c) having a (meth)acryloyl group and a functional group that is capable of reacting with an isocyanate group,
the method comprising reacting the polycarbodiimide (a), the polymer (b), and the compound (c) at 120° C. or lower.

17. (canceled)

18. A method for producing a polycarbodiimide compound, which is a reaction product of
a polycarbodiimide (a) having an isocyanate group at both ends, obtained by polymerizing at least one selected from aliphatic diisocyanate and alicyclic diisocyanate,
a polymer (b) that is a polymer of at least one selected from butadiene and isoprene or a hydrogenated product thereof and has a functional group capable of reacting with an isocyanate group, and
a compound (c) having a (meth)acryloyl group and a functional group that is capable of reacting with an isocyanate group,
the method comprising reacting the polycarbodiimide (a), the polymer (b), and the compound (c) in a solvent.

19. A resin composition comprising a resin (D) having a (meth)acryloyl group and the polycarbodiimide compound obtained by the production method according to claim 16.

20. The resin composition according to claim 19, further comprising a radical polymerization initiator (E).

21. A resin cured product, which is a cured product of the resin composition according to claim 19.
